(19) United States
(12) Patent Application Publication
(10) Pub. No.: US 2015/0047728 A1
(43) Pub. Date: Feb. 19, 2015

(54) FLUID TONER DISPENSING APPARATUS, COMPONENTS, AND METHODS

(71) Applicant: 3M INNOVATIVE PROPERTIES COMPANY, St. Paul, MN (US)

(72) Inventor: Brian S. Boothman, San Jose, CA (US)

(21) Appl. No.: 14/385,527

(22) PCT Filed: Mar. 15, 2013
(86) PCT No.: PCT/US2013/032000

§ 371 Date: Sep. 16, 2014

Related U.S. Application Data
(60) Provisional application No. 61/611,655, filed on Mar. 16, 2012.
(60) Provisional application No. 61/611,658, filed on Mar. 16, 2012.
(60) Provisional application No. 61/611,662, filed on Mar. 16, 2012.

(51) Int. Cl. F16K 23/00

(52) U.S. Cl. CPC F16K 23/00
USPC 137/613

(57) ABSTRACT

This disclosure describes a flow control device comprising: a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber. The flow control device comprises a flow control member adapted to selectively occlude the bleed outlet wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area.

### SUMMARY

In one aspect, this disclosure describes a flow control device. Generally, the flow control device comprises a body that includes a body wall that defines a chamber. An inlet is provided in fluid communication with the chamber, along with a work outlet comprising a work outlet flow area in fluid communication with the chamber, and a bleed outlet comprising an unoccluded bleed flow area in fluid communication with the chamber. The flow control device further comprises a flow control member adapted to selectively occlude the bleed outlet. In a second position, the flow control member at least partially occludes the bleed outlet to create a second bleed flow area. In a first position, the flow control member occludes the bleed outlet to a smaller degree than when in the second position to create a first bleed flow area that is greater than the second bleed flow area.

In some embodiments, the flow control member comprises a flow control core at least partially within the chamber and controllably repositionable with respect to the chamber. The flow control core may comprise a body portion in slidable sealing engagement with the body wall, an actuation control end, and a tip end. The tip end may comprise a medial portion and a distal portion comprising a cross sectional surface area that is less than the unoccluded bleed flow area. In such embodiments, the second position may comprise a forward position wherein the tip end of the flow control core at least partially occludes the bleed outlet to create a second bleed flow area. The first position may comprise a retracted position wherein the tip of end of the flow control core occludes the bleed outlet to a smaller degree than when in the forward position to create a first bleed flow area that is greater than the second bleed flow area.

In some embodiments, when in the forward position, the medial portion of the tip end sealingly engages the bleed outlet so that the tip end of the flow control core fully occludes the bleed outlet.

In some embodiments, when in the retracted position, the tip end of the flow control core does not occlude the bleed outlet.

In some embodiments, the inlet of the flow control device is in fluid communication with a source of fluid pressure.

In some embodiments, the bleed outlet of the flow control device is in fluid communication with a fluid reservoir. In one aspect, the fluid reservoir is in fluid communication with the source of fluid pressure, forming a closed circuit.

In some embodiments, the work outlet of the flow control device is in fluid communication with a work apparatus. In one aspect, the work apparatus comprises a liquid dispenser.

In some embodiments, the unoccluded bleed flow area is greater than the work outlet flow area. In some cases, the unoccluded bleed flow area is greater than the work outlet flow area by a ratio of at least 5:1.

In some embodiments, moving from the second position to the first position comprises moving the flow control member. In one aspect, moving from the second position to the first position comprises moving the body.

In another aspect, the disclosure provides a method comprising providing a flow control device comprising a body comprising a body wall that defines a chamber, the body wall comprising an inlet in fluid communication with the chamber, a work outlet comprising a work outlet flow area in fluid communication with the chamber, and a bleed outlet comprising a unoccluded bleed flow area in fluid communication with the chamber, and a flow control member adapted to selectively occlude the bleed outlet. The method may comprise moving the flow control member between (i) a second position wherein the flow control member at least partially occludes the bleed outlet to create a second bleed flow area; and (ii) a first position wherein the flow control member occludes the bleed outlet to a smaller degree than when in the second position to create a first bleed flow area that is greater than the second bleed flow area.

In some embodiments, the method comprises introducing a pressurized fluid to the chamber through the inlet, wherein as the flow control member is moved from the first position to the second position, fluid pressure through the work outlet increases without a spike from zero pressure.

In some embodiments of the method, the flow control member comprises a flow control core at least partially within the chamber and controllably repositionable with respect to the chamber. The flow control core may comprise comprising a body portion in slidable sealing engagement with the body wall, an actuation control end, and a tip end. The tip end may comprise a medial portion and a distal portion comprising a cross sectional surface area that is less than the unoccluded bleed flow area. The second position may comprise a forward position wherein the tip end of the flow control core at least partially occludes the bleed outlet to create a second bleed flow area. The first position comprising a retracted position wherein the tip of end of the flow control core occludes the bleed outlet to a smaller degree than when in the forward position to create a first bleed flow area that is greater than the second bleed flow area.

In another aspect, the present disclosure provides a method comprising providing a flow control device comprising a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber. The method may comprise introducing a pressurized fluid to the chamber through the inlet to establish a first ratio of fluid flow through the bleed outlet relative to the work outlet. The method may further comprise reducing the unoccluded bleed flow area to a second bleed flow area to establish a second ratio of fluid flow through the bleed outlet relative to the work outlet, the second ratio being less than the first ratio.

In another aspect, the disclosure provides a system for dispensing a fluid. The system comprises a housing comprising a coupler, a pressure outlet, and an actuator. The system comprises a flow control device in controllable communication with the actuator and in fluid communication with the pressure outlet. The flow control device comprises a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber. The flow control device further comprises a flow control member adapted to selectively occlude the bleed outlet. In a second position, the flow control member at least partially occludes the bleed outlet to create a second bleed flow area and. In a first position, the flow control member occludes the bleed outlet to a smaller degree than when in the second position to create a first bleed flow area that is greater than the second bleed flow area. The system further comprises a dispenser assembly comprising a fluid reservoir, and a cap and valve assembly coupled to the housing via the coupler.

In some embodiments, the flow control member comprises a flow control core at least partially within the chamber and controllably repositionable with respect to the chamber. The flow control core comprises a body portion in slidable sealing engagement with the body wall, an actuation control end, and a tip end. The tip end comprises a medial portion and a distal portion comprising a cross sectional surface area that is less than the unoccluded bleed flow area. The second position comprises a forward position wherein the tip end of the flow control core at least partially occludes the bleed outlet to create a second bleed flow area. The first position comprises a retracted position wherein the tip of end of the flow control core occludes the bleed outlet to a smaller degree than when in the forward position to create a first bleed flow area that is greater than the second bleed flow area.

In another aspect, the disclosure provides a device for dispensing fluid from a fluid reservoir comprising a coupler. The device comprises a housing comprising a flow control device in fluid communication with a pressure source and comprising a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber. The flow control device further comprises a flow control member adapted to selectively occlude the bleed outlet. In a second position, the flow control member at least partially occludes the bleed outlet to create a second bleed flow area. In a first position, the flow control member occludes the bleed outlet to a smaller degree than when in the second position to create a first bleed flow area that is greater than the second bleed flow area. The dispensing device further comprises a pressure outlet in fluid communication with the flow control device, an actuator engaged with the flow control core of the flow control device; and a coupler configured to engage a dispenser assembly.

In some embodiments, the flow control member comprises a flow control core at least partially within the chamber and controllably repositionable with respect to the chamber. The flow control core comprises a body portion in slidable sealing engagement with the body wall, an actuation control end, and a tip end. The tip end comprises a medial portion and a distal portion comprising a cross sectional surface area that is less than the unoccluded bleed flow area. The second position comprises a forward position wherein the tip end of the flow control core at least partially occludes the bleed outlet to create a second bleed flow area. The first position comprises a retracted position wherein the tip of end of the flow control core occludes the bleed outlet to a smaller degree than when in the forward position to create a first bleed flow area that is greater than the second bleed flow area.

In some embodiments, the coupler comprises a clip configured to engage a cap and valve assembly.

In another aspect, the present disclosure provides an apparatus for dispensing fluid, the apparatus comprising a housing. The housing comprises a coupler comprising a coupling mechanism configured to sealingly engage at least a portion of a dispenser assembly, a pressure outlet in fluid communication with a pressure source and configured provide fluid communication with a pressure inlet on the dispenser assembly, and an actuator configured to actuate a dispenser assembly, thereby delivering pressure to the dispenser assembly from the pressure outlet.

In some embodiments, the coupling mechanism comprises a clamp configured to engage a coupling platform of the dispenser assembly.

In some embodiments, the coupler is in fluid communication with a first controller.

In some embodiments, the actuator is in fluid communication with a second controller.

In some embodiments, the first controller and second controller are controlled by a sequencer assembly.

In some embodiments, the apparatus further comprises a flow control device in fluid communication with one or more of: the coupler, the actuator, and the pressure outlet. The flow control device comprises a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber. The flow control device further comprises a flow control member adapted to selectively occlude the bleed outlet. In a second position, the flow control member at least partially occludes the bleed outlet to create a second bleed flow area. In a first position, the flow control member occludes the bleed outlet to a smaller degree than when in the second position to create a first bleed flow area that is greater than the second bleed flow area.

In some embodiments, the flow control member comprises a flow control core at least partially within the chamber and controllably repositionable with respect to the chamber. The flow control core comprises a body portion in slidable sealing engagement with the body wall, an actuation control end, and a tip end. The tip end comprises a medial portion and a distal portion comprising a cross sectional surface area that is less than the unoccluded bleed flow area. The second position comprising a forward position wherein the tip end of the flow control core at least partially occludes the bleed outlet to create a second bleed flow area. The first position comprises a retracted position wherein the tip of end of the flow control core occludes the bleed outlet to a smaller degree than when in the forward position to create a first bleed flow area that is greater than the second bleed flow area.

In some embodiments, fluid communication between the flow control device and one or more of the coupler and the actuator comprises fluid communication with an intervening sequencer assembly.

In another aspect, the present disclosure provides a sequencer assembly comprising a body. The body comprises a body wall that defines a lumen, a pressure inlet through the body wall that provides fluid communication between the lumen and a pressure source, a first sequencer control comprising a first sequencer valve and a first pressure outlet providing fluid communication between the first sequencer control and a first output device, and a second sequencer control comprising a second sequencer valve and a second pressure outlet providing fluid communication between the second sequencer control and a second output device. The sequencer assembly comprises a sequencer core slidably positioned in the lumen. In a first position the sequencer core actuates neither the first sequencer valve nor the second sequencer valve. In a second position the sequencer core actuates both the first sequencer valve and the second sequencer valve. In an intermediate position between the first position and the second position, the sequencer core actuates the first sequencer valve but not the second sequencer valve.

In some embodiments, actuating the first sequencer valve releases pressure through the first pressure outlet that actuates the first output device.

In some embodiments, actuating the second sequencer valve releases pressure through the second pressure outlet that actuates the second output device.

In some embodiments, moving the sequencer core from the first position to the second position actuates the first sequencer valve and, after a delay, actuates the second sequencer valve.

In some embodiments, the delay in actuating the second sequencer valve is a function of the distance between the first sequencer valve and the second sequencer valve.

In some embodiments, the delay in actuating the second sequencer valve is a function of the speed at which the sequencer core is moved from the first position to the second position.

In some embodiments, moving the sequencer core from the second position to the first position first de-actuates the second sequencer valve and then de-actuates the first sequencer valve.

In some embodiments, the second position comprises an overtravel distance such that a time delay exists between initiating moving the sequencer core from the second position to the first position and de-actuating the second sequencer valve.

In some embodiments, the sequencer assembly further comprises at least a third sequencer control comprising a third sequencer valve and a third pressure outlet providing fluid communication between the third sequencer control and a third output device.

In another aspect, the present disclosure provides a method of dispensing a fluid, the method comprising providing a system comprising an actuator as described above and actuating the actuator.

In some embodiments, the fluid comprises a liquid.

In some embodiments, the fluid comprises a paint component.

In another aspect, the present disclosure provides a method of delivering a controlled increased air pressure, the method comprising providing an apparatus that comprises an actuator in control of a flow control device. The flow control device comprises a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber. The flow control device further comprises a flow control member adapted to selectively occlude the bleed outlet. In a second position, the flow control member at least partially occludes the bleed outlet to create a second bleed flow area. In a first position, the flow control member occludes the bleed outlet to a smaller degree than when in the second position to create a first bleed flow area that is greater than the second bleed flow area. The method further comprises actuating the actuator such that as the flow control core is moved from the retracted position to the forward position, pressure through the work outlet increases without a spike from zero pressure.

In some embodiments, the flow control member comprises a flow control core at least partially within the chamber and controllably repositionable with respect to the chamber. The flow control core comprises a body portion in slidable sealing engagement with the body wall, an actuation control end, and a tip end. The tip end comprises a medial portion and a distal portion comprising a cross sectional surface area that is less than the unoccluded bleed flow area. The second position comprises a forward position wherein the tip end of the flow control core at least partially occludes the bleed outlet to create a second bleed flow area. The first position comprising a retracted position wherein the tip of end of the flow control core occludes the bleed outlet to a smaller degree than when in the forward position to create a first bleed flow area that is greater than the second bleed flow area.

In another aspect, this disclosure describes a cap and valve assembly for use with a fluid dispensing system. Generally, the cap and valve assembly includes a cap configured to sealingly engage with a coupler component of a fluid reservoir, and an elongate member. The cap generally includes a pressure inlet and a flow inlet. The elongate member generally includes a pressure coupler, a lumen, an outlet aperture, and a repositionable valve core. In a first position of the repositionable valve core, the lumen provides fluid communication between the pressure coupler and the pressure inlet, and the elongate member provides a flow path that provides fluid communication between the flow inlet and the outlet aperture. In a second position of the repositionable valve core, fluid communication between the pressure coupler and the pressure inlet is disrupted.

In some embodiments, the cap and valve assembly can further include a housing coupler configured to engage with a coupling mechanism on the housing of the fluid dispensing system. In some of these embodiments, the housing coupler includes a shoulder configured to be received by a mounting slot on the system housing, and a positioning groove configured to engage a positioning nodule on the system housing.

In some embodiments, the cap and valve assembly can further include a repositionable tip cover wherein, in a first position, the tip cover covers the outlet aperture and, in a second position, uncovers at least a portion of the outlet aperture. In some of these embodiments, repositioning the tip cover from the second position to the first position cleans the outlet aperture. In some of these embodiments, the cap and valve assembly is configured so that the tip cap can be positioned to uncover the outlet aperture independent of providing fluid communication between the pressure coupler and the pressure inlet.

In some embodiments, the valve core further includes at least one seal that, when the valve core is in the second position, is proximal to the outlet aperture and when the valve core is in the first position, the seal is distal to the outlet aperture. In some of these embodiments, the seal at least partially obstructs the flow path when the valve core is in the second position.

In some embodiments, the cap and valve assembly can further include a cap insert configured to sealing engage with a second fluid reservoir coupler.

In some embodiments, the elongate member is detachable.

In some embodiments, the elongate member is sufficiently transparent that contents of the lumen are visible.

This disclosure also describes, in another aspect, a kit that includes at least one modular cap component and at least one modular elongate member component. In some embodiments, the kit can include a plurality of modular cap components. In some embodiments, the kit can include a plurality of modular elongate member components.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

The accompanying drawings are included to provide a further understanding of the invention described herein and are incorporated in and constitute a part of this specification. The drawings illustrate exemplary embodiments. Certain features may be better understood by reference to the following detailed description when considered in connection with the accompanying drawings, in which like reference numerals designate like parts throughout the figures thereof, and wherein:

FIG. 1 is a perspective view of a cross section of one embodiment of a control mechanism as described herein.

FIG. 2 is a perspective view of the cross section of the embodiment of the control mechanism illustrated in FIG. 1 in a partially actuated position.

FIG. 3 is a perspective view of the cross section of the embodiment of the control mechanism illustrated in FIG. 1 in a fully actuated position.

FIG. 4 is a side view cross section of a second embodiment of a control mechanism as described herein.

FIG. 5 is a side view cross section of the second embodiment of the control mechanism illustrated in FIG. 4 in an actuated position.

FIG. 6 is a schematic diagram of one embodiment of the fluid dispensing system described herein.

FIG. 7 is a schematic diagram of a second embodiment of the fluid dispensing system described herein.

FIG. 8 is a schematic diagram of a third embodiment of the fluid dispensing system described herein.

FIG. 9 is a schematic diagram of a fourth embodiment of the fluid dispensing system described herein.

FIG. 10 is a perspective view cross section of one embodiment of a dispensing assembly as described herein.

FIG. 11 is a perspective view of one embodiment of a fluid dispensing system as described herein.

FIG. 12 is a perspective view cross section of one embodiment of a sequencer assembly as described herein.

FIG. 13 is a perspective view cross section of a second embodiment of a sequencer assembly as described herein.

FIG. 14 is a perspective view of one embodiment of sequencer assembly components of a fluid dispensing system as described herein.

FIG. 15 is a side view cross section of a second embodiment of a dispensing assembly as described herein.

FIG. 16 is a side view cross section of the embodiment of a dispensing assembly illustrated in FIG. 15 in an actuated position.

FIG. 17 is a perspective view of a portion of one embodiment of the fluid dispensing system described herein.

FIG. 18 is a top perspective view of one embodiment of a dispensing assembly as described herein.

FIG. 19 is a perspective view of one embodiment of a fluid dispensing system as described herein.

FIG. 20 is a perspective cross sectional view of one embodiment of a sequencer assembly as described herein.

FIG. 21 is a line graph comparing work pressure transmitted by one embodiment of a flow control device as described herein with work pressure transmitted by a conventional high precision pressure regulator.

FIG. 22 is a side cross sectional view of one embodiment of coupling between a bench top system and a dispensing assembly, each as described herein.

FIG. 23 is an exploded view of a modular elongate member component as described herein.

FIG. 24 is a perspective view of the configuration of a modular elongate member as described herein with two different modular cap components as described herein.

FIG. 25 is a cross sectional view of one embodiment of a cap and valve assembly engaged with a coupler of a bench top system in an “up,” or disengaged state.

FIG. 26 is a cross sectional view of one embodiment of a cap and valve assembly engaged with a coupler of a bench top system in a “down,” or locked position.

FIG. 27 is a perspective view of one embodiment of a cap and valve assembly engaged with a coupler of a bench top system in an “up,” or disengaged state.

FIG. 28 is a perspective view of one embodiment of a cap and valve assembly engaged with a coupler of a bench top system in a “down,” or locked position.

FIG. 29 is a rear perspective view of the cap and valve assembly engaged with a coupler of a bench top system shown in FIG. 27.

### DETAILED DESCRIPTION OF ILLUSTRATIVE EMBODIMENTS

A system for dispensing a fluid is described herein. As used herein, the term “fluid” refers generally to any material that flows under applied shear stress. The term “fluid” can therefore refer to either a liquid or a gas. The system includes various components that contribute to certain features of operation. For example, the system can include a fluid control valve that can allow an operator to more precisely control dispensing small volumes of fluid, whether the small volume is the total amount of fluid to be dispensed or, as in some applications, the small volume reflects the end of dispensing a larger volume, but must be done with precision and accuracy. As another example, the system can contain a dispensing assembly that can be customized to fit fluid containers provided by various suppliers. As yet another example, the system can include a sequencer assembly that can automatically sequence certain functions of the system to reduce the likelihood and/or extent of certain types of dysfunction such as, for example, uncontrolled pressure release.

In various portions of the description that follows, reference may be made to one particular exemplary embodiment in which the fluid dispensing system is configured and/or used for dispensing toner, such as may occur in the formulation of auto body paint. Unless otherwise specifically noted, such descriptions are mere exemplary illustrations of one embodiment and the general features, general implementations, general methods, and general processes described may apply equally to other embodiments directed toward the dispensing of other fluids.

In the automotive body repair industry, paint vendors provide auto body repair businesses, such as body shops and jobbers, with paint formulas. Generally, these paint formulas are a composition (i.e., mixture) of stock paint components such as, for example, colorants, tints, pearls, metallics, binders and/or balancers, that, once mixed, produce the desired color of paint to be applied to a repaired vehicle. The paint formulas provided by paint vendors are formulated to match vehicle paint colors that have been applied to new vehicles. In addition, these paint formulas can include variants to, for example, match the fading of paint that can occur over years of service.

Typically, a paint formula is provided in terms of mixing quantities that can be expressed in grams, sometimes to a precision of a tenth of a gram. Depending on the desired color, the paint formula can require anywhere from a few paint components to over a dozen paint components that must be mixed with a great degree of precision to achieve a proper color match.

Conventional paint mixing is a manual process. A user typically refers to the paint formula provided by a manufacturer, then manually pours each paint component into a container until the specified amount of each component has been poured. However, manual pouring often leads to inaccurate pours, especially when a precise amount of each component is required to form a specific paint mixture. For even a highly skilled operator, the degree of precision needed to accurately and precisely hand pour certain paint formulas can be difficult to obtain. One common error that can result from manual pouring is over pouring. Over pouring occurs when the weight of the paint component added to the paint mixture exceeds the amount called for in the paint manufacturer's formula. When this happens, one must recalculate the weights of the other paint components to compensate for the over poured component. While the recalculation can be automated, the operator must re-pour additional amounts of already poured components to correct for the over poured component. Additional errors during the re-pouring process can exacerbate the original over pour. In all, over pouring can result in an increase in the time needed to formulate a paint mixture, an increase in waste material (e.g., unused paint formulation), and, because certain paint components can be quite expensive, increased cost.

Powered dispensing devices typically use one or more motors to control a spout for a container of paint component. However, conventional motorized dispensers do not always adjust quickly and can often over pour or under pour one or more paint components. Conventional motorized dispensing devices can use a pump that requires occasional calibration. Additionally, conventional spouts can be poorly sealed, which can lead to dripping, the introduction of contaminants into paint component containers, and/or curing of paint components within the containers. Thus, conventional spouts require periodic cleaning, especially when changing empty toner containers.

We therefore describe herein a system for dispensing a fluid that permits one to accurately and precisely dispense a fluid. Within the system, we describe various components that can contribute to the operation of the system.

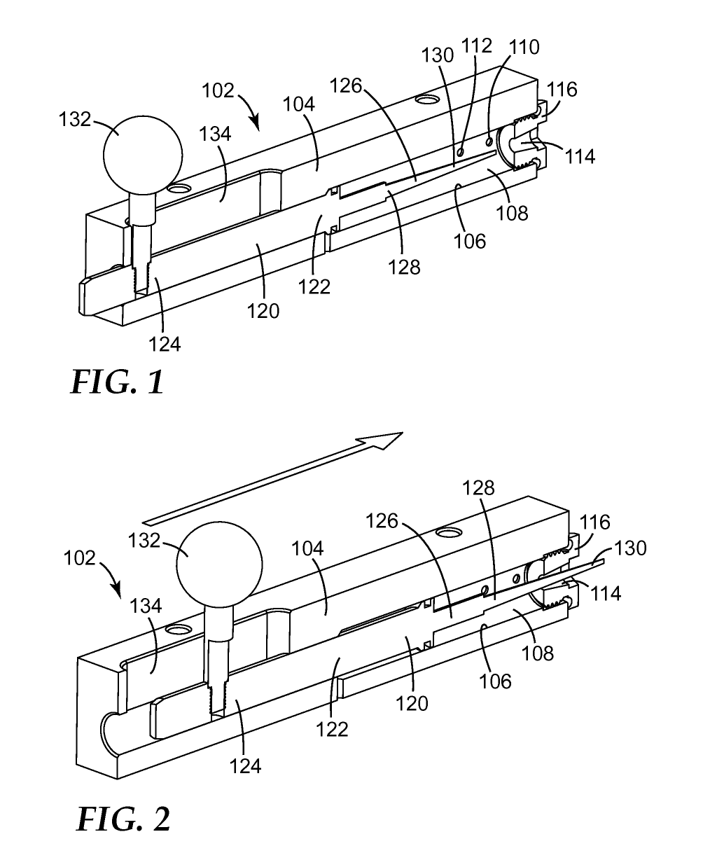

One such system component is a flow control device 102 as shown, for example, in FIGS. 1-3. The flow control device 102 includes a body 104 that includes an internal body wall 106 that defines a chamber 108. The body wall 106 also includes an inlet 110 in fluid communication with the chamber 108, a work outlet 112 in fluid communication with the chamber 108, and a bleed outlet 114 in fluid communication with the chamber 108. The opening of the work outlet 112 that provides fluid communication with the chamber 108 has a flow area. Similarly, the opening of the bleed outlet 114 has a flow area. As shown in the appended Figures, the inlet 110, the work outlet 112, and the bleed outlet 114 each comprise a single opening. However, it should be understood that these features can each comprise more than one opening, and/or other fluid pervious structure or material, within the scope of this disclosure.

The flow control device 102 also includes a flow control member 120. The flow control member 120 may comprise any structure or combination of features adapted to selectively throttle or restrict fluid flow through the bleed outlet 114. For example, the flow control member 120 may comprise a single or multi-leaf shutter mechanism (e.g., akin to a camera shutter) adapted to occlude (partially or fully) the bleed outlet 114. In another example, the flow control member may comprise a variable constriction acting upon the bleed outlet to reduce or expand the effective diameter(s) of the bleed outlet 114 flow passage(s). In yet another example, the flow control member 120 may comprise a gate member (e.g., akin to a guillotine) adapted to occlude (partially or fully) the bleed outlet 114. Any other device adapted to provide proportional flow control through the bleed outlet may be used as the flow control member 120 within the scope of the present disclosure.

In the appended Figures, the flow control member 120 is shown to comprise a flow control core positioned at least partially within the chamber 108. For convenience throughout, the flow control core is described as an exemplary embodiment of a flow control member 120. Although the flow control core may comprise certain advantages as described herein, it should be understood that any flow control member 120 contemplated by this disclosure could be substituted throughout for the flow control core.

The flow control core includes a body portion that is in slidable sealing engagement with at least a portion of the body wall 106 so that as the flow control core is repositioned with respect to the chamber 108, the body portion 122 of the flow control core maintains a fluid tight seal that limits release of fluid pressure from the chamber 108 past the body portion 122 and actuation control end 124 of the flow control core.

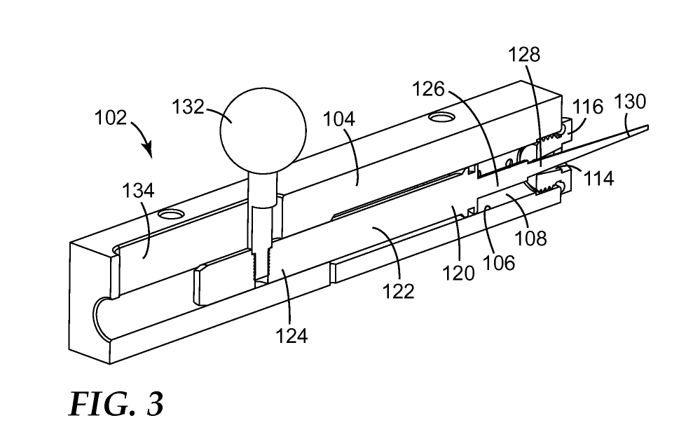

The flow control core also includes an actuation control end 124 and a tip end 126. The tip end 126 includes a medial portion 128 and a distal end 130. The distal end 130 has a cross sectional surface area that is less than the flow area of the bleed outlet 114 so that as the flow control core is repositioned forward with respect to the chamber 108, as shown in FIG. 2 and FIG. 3, at least a portion of the distal end 130 of the flow control core occludes at least a portion of the bleed outlet 114.

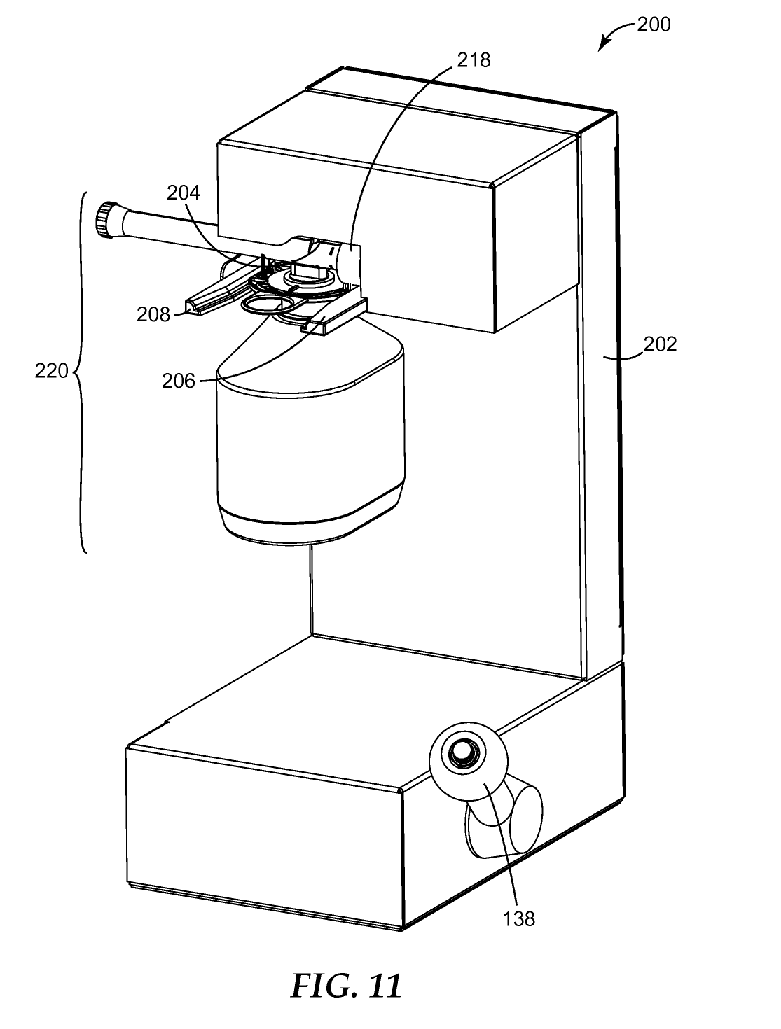

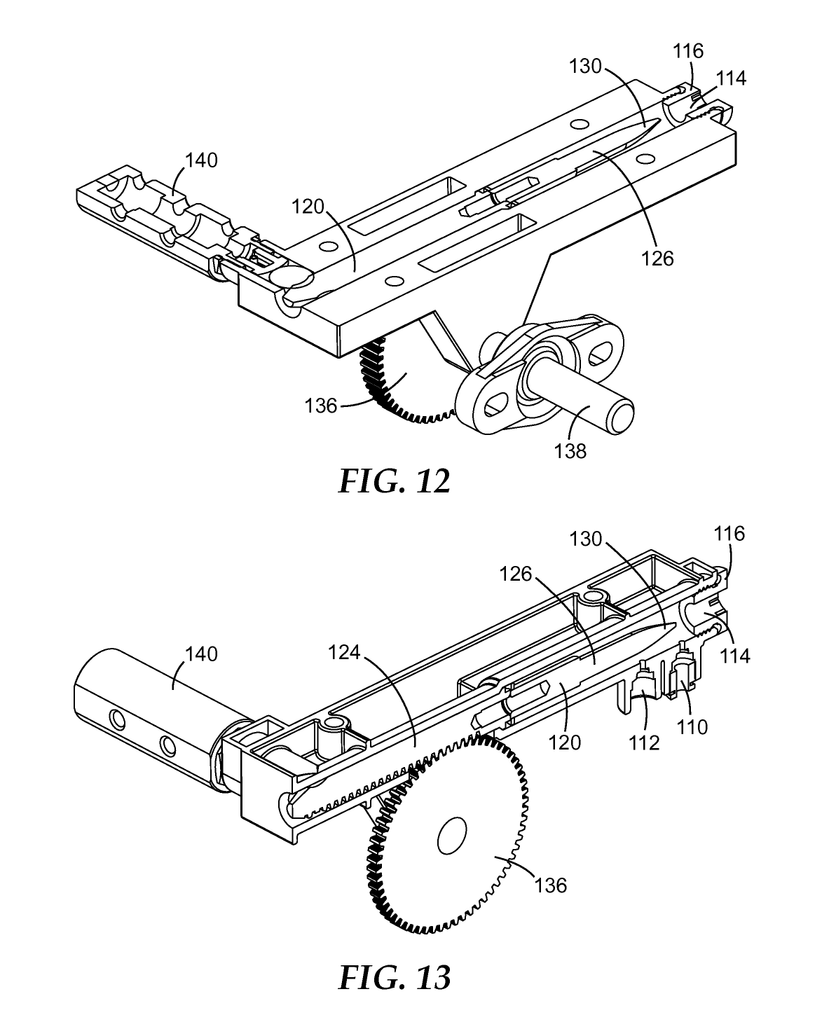

The actuation control end 124 of the flow control core can include and actuator that can include any suitable mechanism for controllably repositioning the flow control core with respect to the chamber 108. FIGS. 1-3 illustrate one embodiment in which the actuator can be, for example, a knob 132 physically attached to the flow control core. Sliding the actuator knob 132 along a slot 134 repositions the flow control core with respect to the chamber 108. In other embodiments, the actuator may be a rotatable handle 138 as illustrated in FIG. 11. In such embodiments, rotational movement of the handle 138 may be transformed to sliding repositioning of the flow control core with respect to the chamber 108 through one or more gear mechanisms 136, as shown in FIG. 12 and FIG. 13. The specific form and/or design of the actuator is unimportant so long as the actuator is able to be repositioned in a way that controllably repositions the flow control core with respect to the chamber 108.

Actuating the flow control device 102 can involve any manner of repositioning the flow control member 120 with respect to the chamber 108. Thus, in some embodiments (not shown), moving the flow control member 120 relative to the chamber 108 can involve repositioning the body 104 relative to a stationary flow control member 120. In such embodiments, the actuator can be a mounting that connects the flow control member 120 to a component that holds the flow control member 120 stationary while the body 104 is repositioned relative to the flow control member 120. In still other embodiments, movement of the flow control member 120 relative to the chamber 108 can involve movement of both the flow control member 120 and the body 104. In such embodiments, the movements of the flow control member 120 and the body 104 may be in opposite directions, or may involve any simultaneous movement that results in repositioning the flow control member 120 with respect to the chamber 108 or, more particularly, the bleed outlet 114.

FIG. 1 shows the actuator 132 and flow control member 120 (in this case a flow control core) in a first, closed position. FIG. 2 and FIG. 3 illustrate progressive actuation of the flow control device 102 in which the flow control member 120 is repositioned with respect to the chamber 108 through an intermediate position (FIG. 2) to a full forward position (FIG. 3). Although FIG. 1 illustrates the flow control device 102 so that the distal end 130 of the flow control core occludes none of the bleed outlet 114, in some embodiments, the distal end 130 of the flow control core may occlude a portion of the bleed outlet 114 in the first position. Similarly, while FIG. 3 illustrates the distal end 130 of the flow control core fully occluding the bleed outlet 114, in some embodiments, the distal end 130 of the flow control core may not necessarily fully occlude the bleed outlet 114 in a full, forward position.

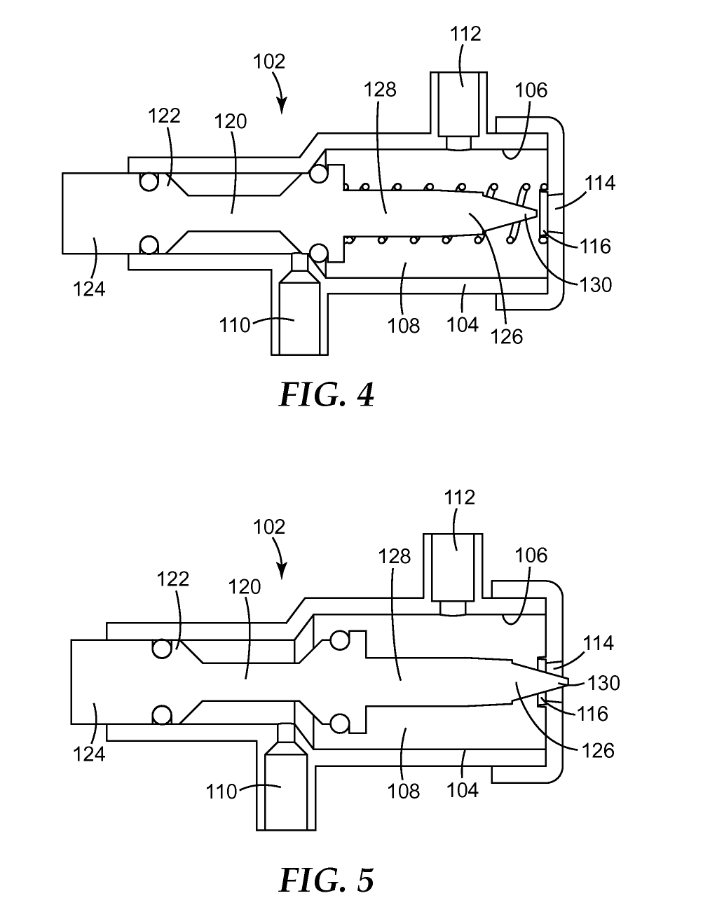

While FIGS. 1-3 illustrate an embodiments in which the inlet 110 remains in fluid communication with the chamber 108 throughout all repositioning of the flow control member 120, FIG. 4 illustrates an embodiment in which fluid communication between the inlet 110 and the chamber 108 can be obstructed by a portion of the flow control member 120 in the first, closed position.

In some embodiments, the inlet 110 may be in fluid communication with a pressure source so that when the inlet 110 is not obstructed by the flow control member, pressure from the pressure source is transmitted through the inlet 110 into the chamber 108. The configuration of the inlet 110, flow control member 120, bleed outlet 114, and work outlet 112 allow fine level control of pressure transmitted through the flow control device 102 and out of the work outlet 112. The flow control device 102 can permit both high work pressure to be transmitted through the work outlet 112—such as may be desired for rapid, high volume dispensing—as well as fine control such as is made possible by transmitting low work pressure through the work outlet 112.

In some embodiments, therefore, the flow control device 102 can deliver work pressure having a minimum value of, for example, at least 0.010 PSI, at least 0.020 PSI, at least 0.030 PSI, at least 0.033 PSI, at least 0.036 PSI, at least 0.040 PSI, at least 0.043 PSI, at least 0.046 PSI, at least 0.050 PSI, at least 0.053 PSI, at least 0.056 PSI, at least 0.060 PSI, at least 0.063 PSI, at least 0.066 PSI, at least 0.070 PSI, at least 0.075 PSI, at least 0.080 PSI, at least 0.085 PSI, at least 0.090 PSI, at least 0.095 PSI, or at least 0.10 PSI. The flow control device 102 also can deliver a maximum work pressure of no more than 100 PSI, no more than 90 PSI, no more than 80 PSI, no more than 70 PSI, no more than 60 PSI, no more than 50 PSI, no more than 40 PSI, no more than 30 PSI, no more than 25 PSI, no more than 20 PSI, no more than 15 PSI, no more than 10 PSI, no more than 9 PSI, no more than 8 PSI, no more than 7 PSI, no more than 6 PSI, no more than 5 PSI, no more than 4 PSI, no more than 3 PSI, no more than 2 PSI, or no more than 1 PSI. The work pressure delivered by the flow control device 102 may be expressed as a range having, as endpoints, any minimum work pressure listed above and any maximum work pressure listed above that is greater than the minimum work pressure. In one particular embodiment, the flow control device 102 can deliver a range of work pressures having a minimum of 0.036 PSI and having a maximum of 25 PSI.

Many conventional pressure regulation devices exhibit what is known as “crack pressure.” This term relates to the tendency of the device to rise from zero pressure with a spike. This spike can limit the extent to which the system can smoothly and variably apply very low pressures in a controlled manner while still being able to apply the relatively high pressures that can be desirable during, for example, a rapid dispensing phase of a dispense cycle. The pressures required during a rapid dispensing phase can be several hundreds of times greater than the pressures required during a low pressure, precise finishing phase of a dispense cycle.

The flow control device 102 is designed to rise from zero pressure to a pressure controlled by the user without a spike or other sudden jump in pressure. This is achieved by a “controlled bleed” strategy that involves the bleed outlet 114. When the flow control device 102 is in the idle state—when the flow control member is repositioned such that the bleed outlet 114 is minimally occluded (or unoccluded) (e.g., in the flow control core embodiment, just forward from the position shown in FIG. 1 so that the inlet 110 is no longer obstructed) the vast majority of the pressure transmitted into the chamber 108 through the inlet 110 is released through the bleed outlet 114.

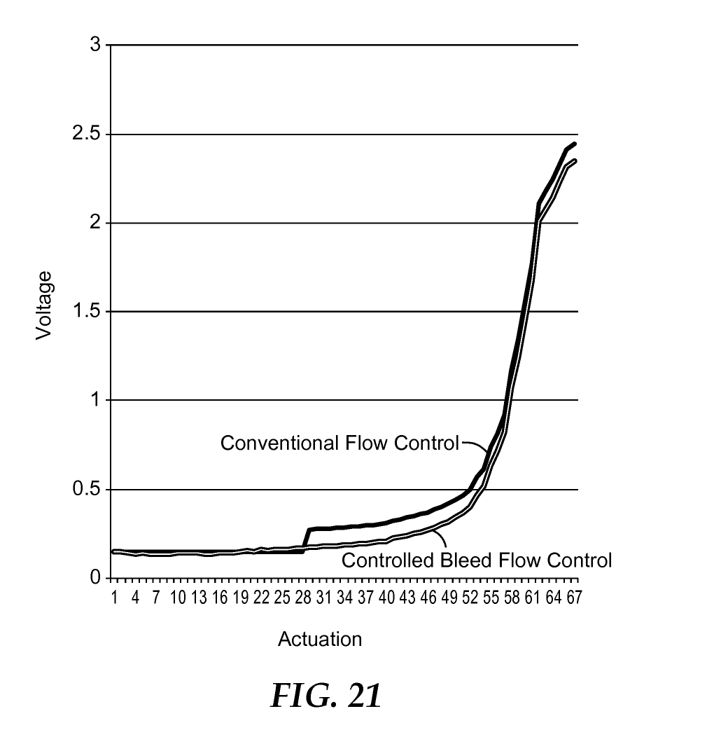

FIG. 21 illustrates how the controlled bleed feature of the flow control device 102 compares to conventional flow control designs that are susceptible to “crack pressure” at low pressures. The curve representing work pressure measured from a flow control device 102 as described herein rises from zero in a smooth, gradual fashion. In contrast, the “crack pressure” representative of a conventional device exhibits a spike in pressure as work pressure rises from zero. The existence of the “crack pressure” makes it difficult to accurately and precisely control work pressure at very low pressures consumed within the spike.

Generally, the ratio of the bleed outlet 114 flow area to the work outlet 112 flow area determines the ratio of the pressure transmitted through the bleed outlet 114 versus the pressure transmitted through the work outlet 112. As used herein, “flow area” means the cross-sectional area of the open portion of a fluid outlet (e.g., the bleed outlet 114 or the work outlet 112), in conjunction with the geometry and properties of the surfaces that form and surround the fluid outlet, acting together to result in a certain flow rate through the fluid outlet for a given fluid at a given pressure drop across the fluid outlet. For example, if a fluid on the common upstream side of first and second fluid outlets is at a certain pressure, then the fluid will flow at a higher rate through whichever fluid outlet comprises the greater flow area. For a simple circular orifice or annulus, flow area may be largely determined by the open cross-sectional area of the shape. However, certain surface features may induce turbulence or greater flow resistance, and therefore cause a net reduction in flow area. Moreover, by way of example, the profile of the distal end 130 of the flow control core and the an inner profile of the bleed outlet 114 may be chosen such that, as the two profiles nest in a given position, greater or lesser flow restriction can be realized, thus resulting in respective greater or lesser flow area.

As the flow control core is repositioned forward so that the distal end 130 begins to occlude a portion of the bleed outlet 114, the ratio of the bleed outlet 114 flow area and the work outlet 112 flow area change and, consequently, the relative pressures transmitted through the bleed outlet 114 and the work outlet 112 change. In certain embodiments, the flow control device 102 can be configured with a ratio of bleed outlet 114 flow area to work outlet 112 flow area so that the observed pressure transmitted through the work outlet 112—i.e., the “work pressure”—can be near zero. As one slowly advances the flow control core so that the distal end 130 begins to occlude the bleed outlet 114, the pressure transmitted through the work outlet 112 will increase at a smooth and controllable rate. This permits the user to easily control the flow rate of fluid (e.g., a paint component) dispensed during a low pressure dispensing phase such as, for example, a finishing phase—a phase in which accurate and precise dispensing may be desirable.

When one advances the flow control core to a full forward position, the ratio of the bleed outlet 114 flow area to work outlet 112 flow area is minimized and pressure transmitted through the work outlet 112 is maximized, allowing for rapid dispensing of fluid. In embodiments in which the bleed outlet 114 is fully occluded when the flow control core is in the fully forward positions (e.g., as shown in FIG. 3), the pressure transmitted through the work outlet 112 will be nearly equal to the pressure supplied to the flow control device 102 through the inlet 110. The combination of these flow control characteristics at both high pressure and at low pressure allows one to rapidly dispense fluid (e.g., at high pressure) as well as easy, accurate, and/or precise low pressure dispensing without experiencing the “crack pressure” phenomenon.

The tip end 126 of the flow control core can be configured to provide any desired pressure transition pattern as the flow control core is repositioned forward to occlude at least a portion of the bleed outlet 114. The flow control core shown in FIGS. 1-3 has a relative long tip end 126 having a gradual increase in diameter. Such a design can deliver slow, gradual, even increases in the pressure that is transmitted to the work outlet 112 as the flow control core is repositioned forward. However, other configurations of the tip end 126 of the flow control core may be designed. For example, a tip end 126 that possess a shorter distal end 130 and a less gradual tapering may more rapidly increase the pressure transmitted through the work outlet 112 as the tip end 126 is repositioned forward to at least partially occlude the bleed outlet 114. (See, e.g., FIG. 4 and FIG. 5). Such a design may be desirable for dispensing fluids that, for example, do not require fine, low pressure dispensing. As another example, a longer tip end 126 may allow an even more gradual increase in diameter and a corresponding more gradual increase in pressure transmitted through the work outlet 112 as the tip end 126 is repositioned forward to at least partially occlude the bleed outlet 114. This may be desirable for dispensing fluids in which, for example, fine, precise, accurate measurements is of primary importance. Such a design may be complemented by a configuration, such as is shown in FIG. 1, in which in the idle position, the distal end 130 occludes no portion of the bleed outlet 114. As one final example, a tip end 126 may be designed so that the rate at which the diameter of the of the tip end 126 changes. For example, the distal end 130 may be long and narrow with a slow and gradual increase in diameter, while the medial portion 128 may increase in diameter more rapidly than the distal end 130 increases in diameter. Such a configuration may combine the ability to precisely dispense at low pressure—due to the slow and gradually increasing diameter of the distal end 130—and then rapidly transition to rapid, high pressure dispensing—due to the more rapid increase in diameter of the medial portion 128 and the corresponding more rapid occlusion of the bleed outlet 114 as the flow control core is repositioned forward.

Because the tip end 126 can be configured to provide any desired pressure transition pattern, the flow control core can be configured so that the distal end 130 can be an interchangeable part, allowing one to select an interchangeable distal end 130 of the flow control core that delivers a pressure transition pattern that is appropriate for a given application. Thus, in some embodiments, the flow control core may be configured to include any appropriate mechanism for coupling with a replaceable distal end 130. Exemplary coupling mechanisms can include a screw threading, a collet, a snap fitting, or a press fitting. In some embodiments, in may be possible before use to advance the flow control core a position such as that shown in FIG. 3, so that the distal end 130 is accessible for interchanging parts.

In some embodiments, the bleed outlet 114 can include a bleed outlet seal 116. A bleed outlet seal 116 may be composed of any material that can provide a fluid tight seal with the flow control member 120 (e.g., a sliding fluid tight seal with the tip end of the flow control core, in the embodiments shown). Thus, a bleed outlet seal 116 may include an elastomeric material such as, for example, a natural or synthetic rubber.

In some embodiments, the bleed outlet 114 may be in fluid communication with a fluid reservoir. In some of these embodiments, the fluid reservoir also may be in fluid communication with the inlet 110. In such embodiments, fluid—whether liquid or gaseous—used to transmit fluid pressure from the pressure source into the flow control device 102 may be recycled.

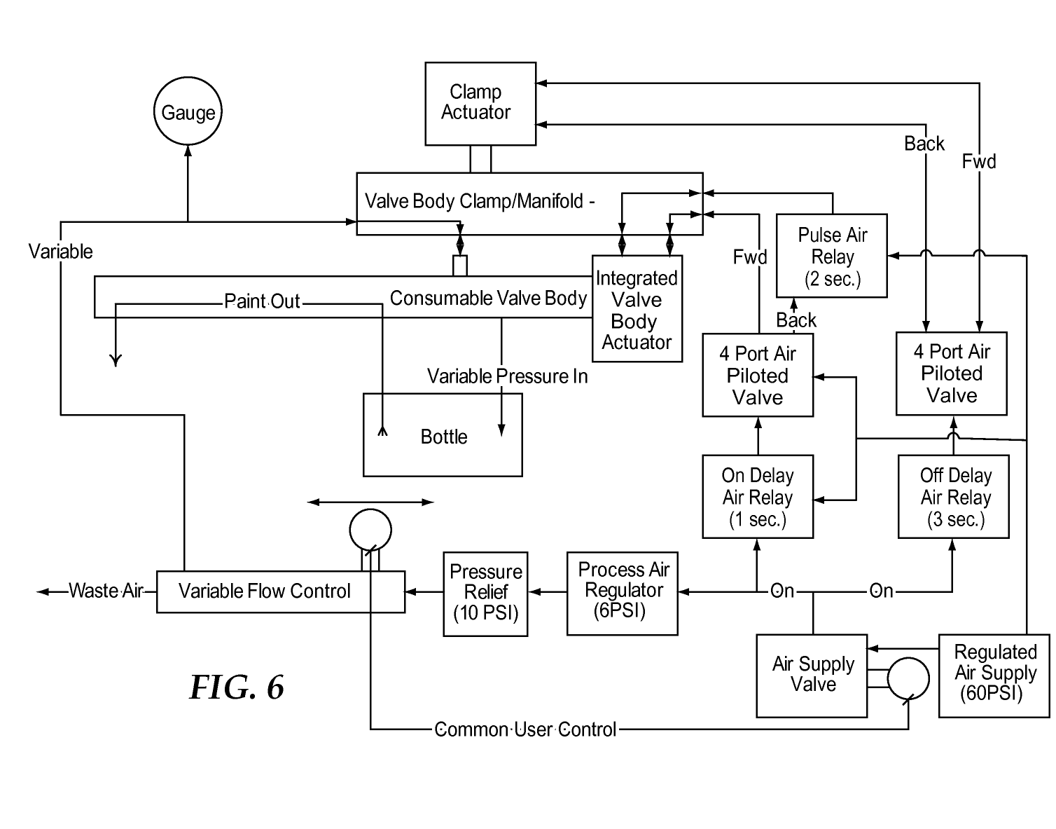

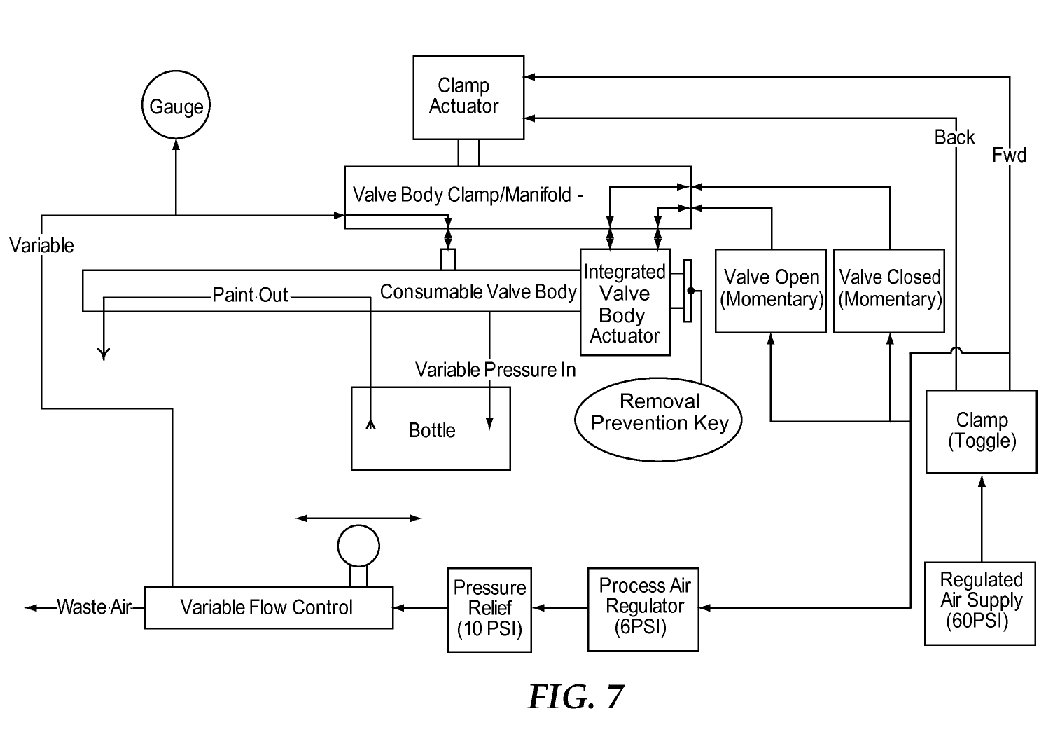

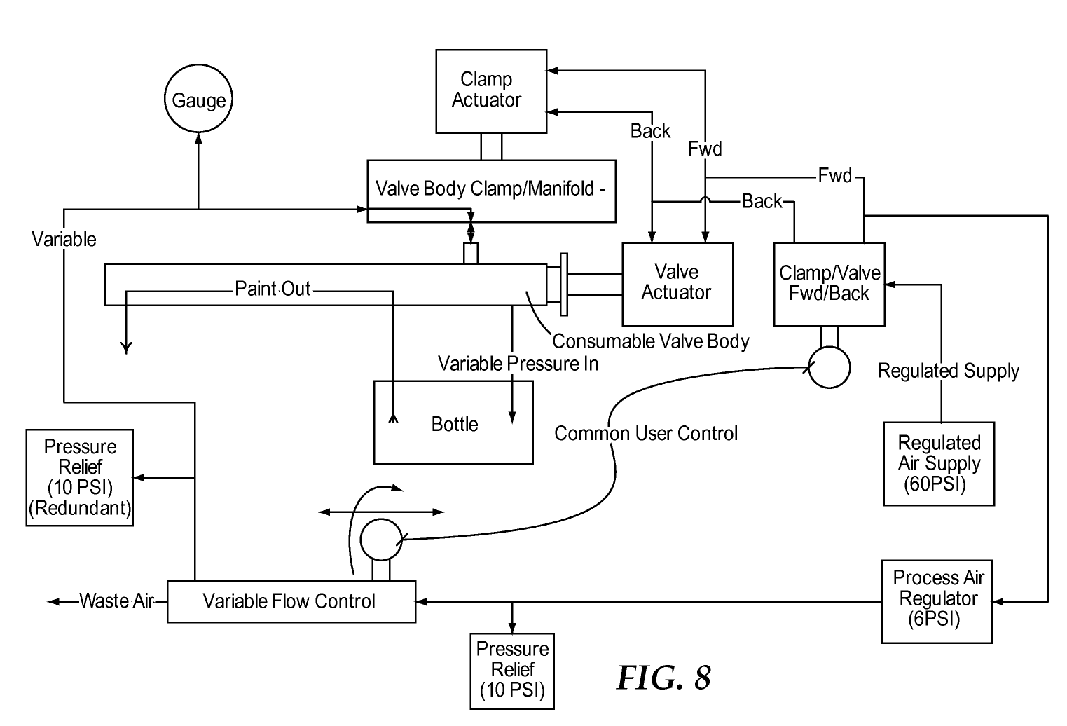

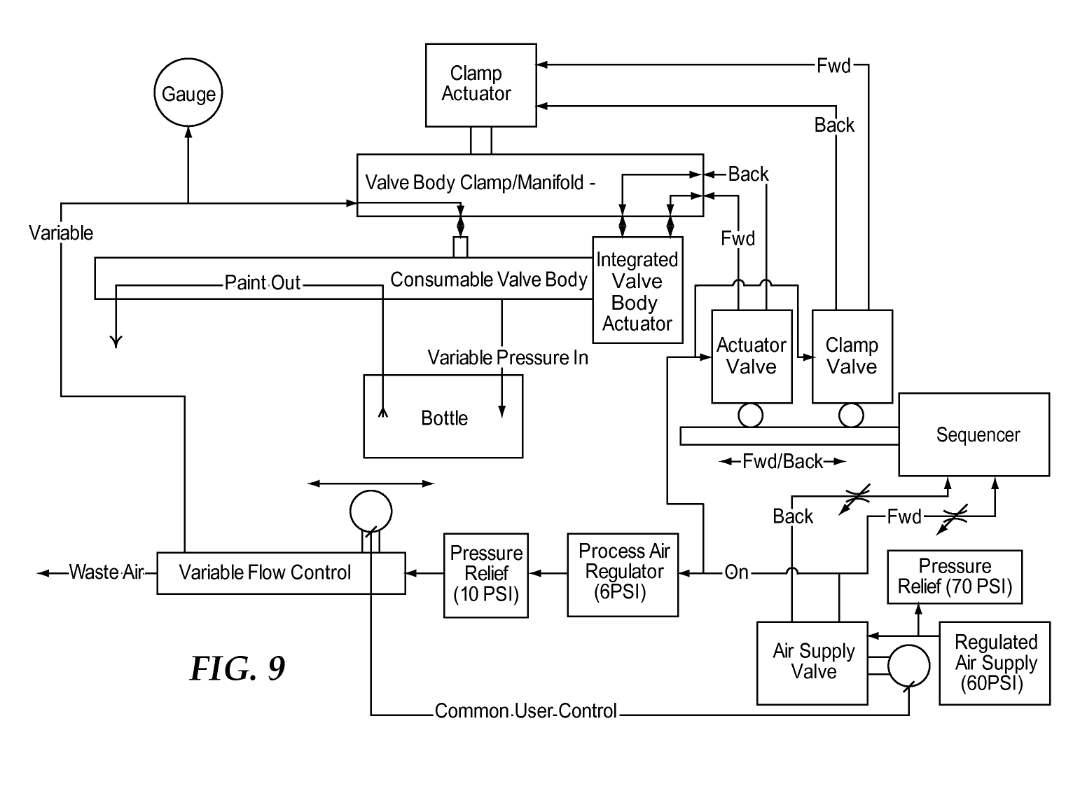

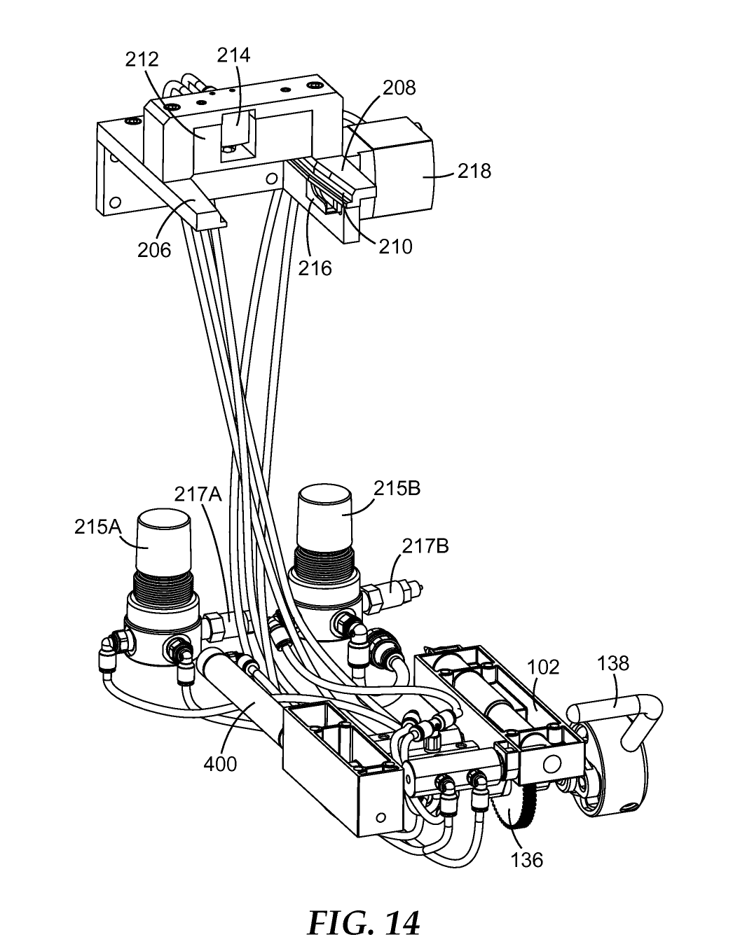

In some embodiments, the work outlet 112 may be in fluid communication with a work apparatus. Generally, a work apparatus may be any apparatus that can employ pressure transmitted to it from the work outlet 112 to accomplish a mechanical function. In the system illustrated in FIG. 11, a work apparatus may include, for example, a dispenser of liquid. More specifically, the work outlet 112 may be in fluid communication with a component of the work apparatus configured to perform a specific pressure-regulated function. In the system illustrated in FIG. 14, and represented schematically in FIGS. 6-9, the work outlet 112 may be in fluid communication, and therefore regulate the function of, for example, a valve body actuator and/or a valve body clamp. As indicated above, when the flow area of the bleed outlet 114 is greater than the flow area of the work outlet 112, then the flow control device 102 can produce a near zero work pressure. Thus, in some embodiments, the flow area of the bleed outlet 114 may be greater than the flow area of the work outlet 112 by a predetermined ratio. The predetermined ratio may be a ratio having a minimum of at least 5:1 such as, for example, at least 10:1, at least 15:1, at least 20:1, at least 25:1, at least 30:1, at least 35:1, at least 40:1, at least 45:1, at least 50:1, at least 55:1, at least 60:1, at least 65:1, at least 70:1, at least 75:1, at least 80:1, at least 85:1, at least 90:1, at least 95:1, at least 100:1, or at least 105:1. The predetermined ratio may be a ratio having a maximum of no more than 120:1, no more than 110:1, no more than 100:1, no more than 95:1, no more than 90:1, no more than 85:1, no more than 80:1, no more than 75:1, no more than 70:1, no more than 65:1, no more than 60:1, no more than 55:1, no more than 50:1, no more than 45:1, no more than 40:1, no more than 35:1, no more than 30:1, no more than 25:1, or no more than 20:1. The predetermined ratio also may be expressed as a range having, as endpoints, any minimum ratio listed above and any maximum ratio listed above that is greater than the minimum ratio. In various specific embodiments, the ratio of the bleed flow area to the work flow area can be, for example, 10:1, 25:1, 50:1, or 64:1.

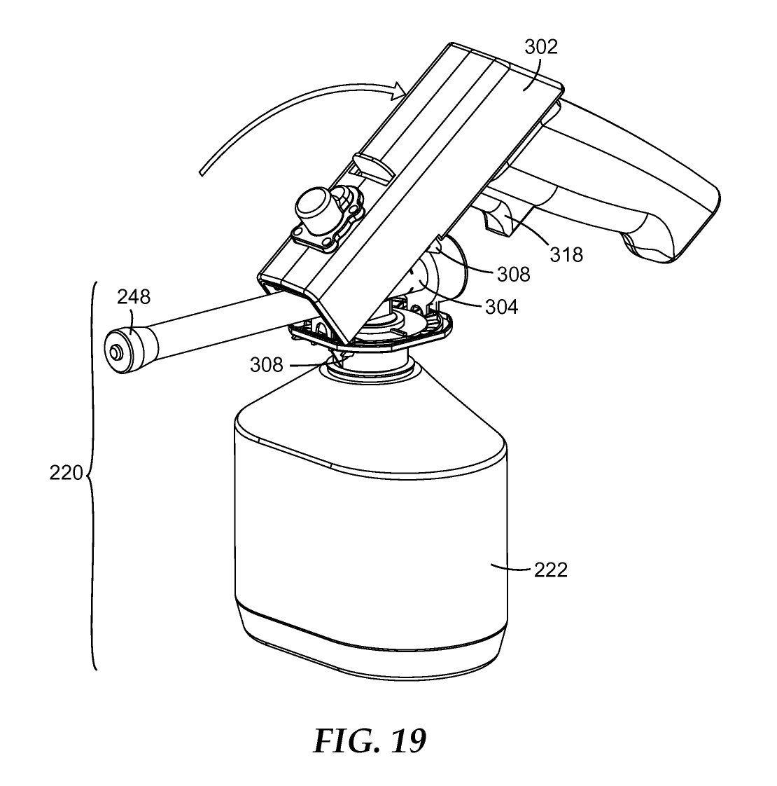

Various embodiments of the flow control device 102 describe above may be a component of a fluid dispensing system. In some cases, the fluid dispensing system may be a bench top fluid dispensing system 200 such as the system illustrated in FIG. 11. In other cases, the fluid dispensing system may be a handheld fluid dispensing system 300 such as the system illustrated in FIG. 19. Whether a bench top system or a hand held system, the fluid dispensing system generally includes a housing that includes a coupler, a pressure outlet, and an actuator; and a flow control device 102, as described above, in mechanical communication and/or fluid communication with the actuator and in fluid communication with the pressure outlet. The system also includes a dispenser assembly that includes a fluid reservoir and a cap and valve assembly, described in more detail below that couples the fluid reservoir to the housing via the housing coupler.

An exemplary hand held dispensing system 300 is illustrated in FIG. 19. The hand held system includes a housing 302 that includes a flow control device 102 (not shown) in fluid communication a pressure source and in fluid communication with a pressure outlet 304. The pressure outlet 304 may be configured to align with and/or otherwise provide fluid communication with a pressure inlet component of a dispensing assembly 200, described in more detail below. The flow control device is also engaged with the actuator 318. The housing 302 also includes a coupler 306. In the embodiment shown in FIG. 19, the coupler 306 includes a series of clips 308 that are configured to engage receiving slots on a dispenser assembly 220. FIG. 19 illustrates one exemplary configuration of clips 308 engaging the dispensing assembly.

In some embodiments, the hand held system 300 can employ a somewhat simpler design of flow control device 102 because of space limitations. One exemplary flow control device 102 design suitable for use in a hand held device 300 is illustrated in FIG. 4 and FIG. 5. In use, depressing the actuator 318 (FIG. 19) can reposition the flow control core from an original position such as that shown in FIG. 4 to an actuated position such as is shown in FIG. 5. In the actuated position shown in FIG. 5, pressure enters the flow control device 102 through the inlet 110, traverses the chamber 108, and, depending on the extent of actuation, exits the chamber through the bleed outlet 114 and/or work outlet 112. The work outlet 112 (shown in FIG. 5) is in fluid communication with the pressure outlet 304 in the housing 302 of the hand held system 300 (shown in FIG. 19). Pressure transmitted from the work outlet 112 is subsequently transmitted through the pressure outlet 308 and to the dispensing assembly 220.

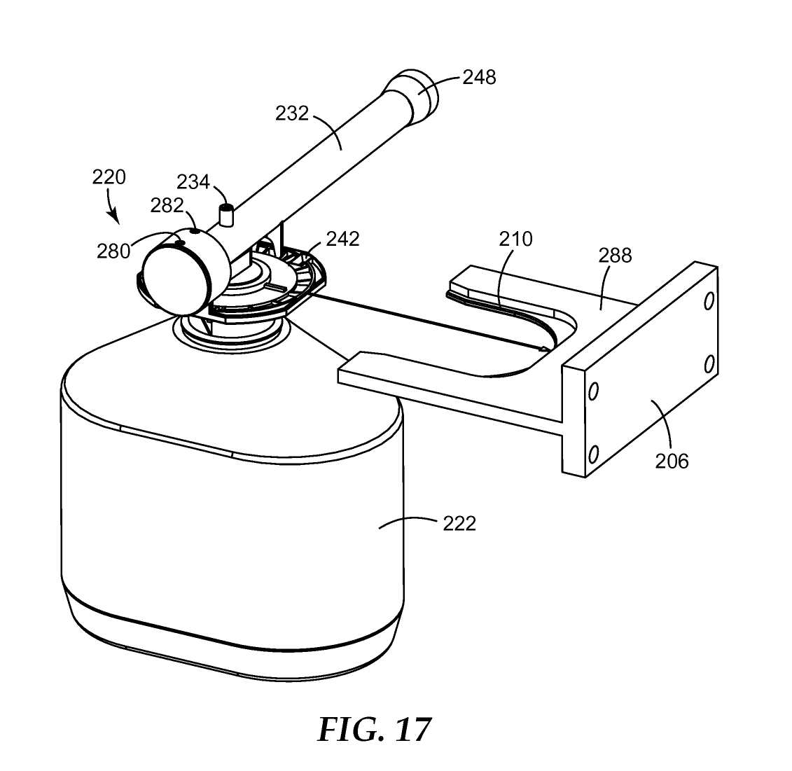

An exemplary bench top fluid dispensing system 200 is illustrated in FIG. 11. The bench top system 200 includes a housing 202 that includes a coupler 206 (various components of which are shown in more detail in FIG. 14. and FIG. 17) configured to sealingly receive and/or engage a dispensing assembly 220. The housing also includes a pressure outlet 204 and an actuator 218. The bench top system 200 provides fluid communication between a pressure source (e.g., through the flow control device 102) and the pressure outlet 204. The pressure outlet 204 may be configured to align with and/or otherwise provide fluid communication with a pressure inlet component of a dispensing assembly 200, described in more detail below.

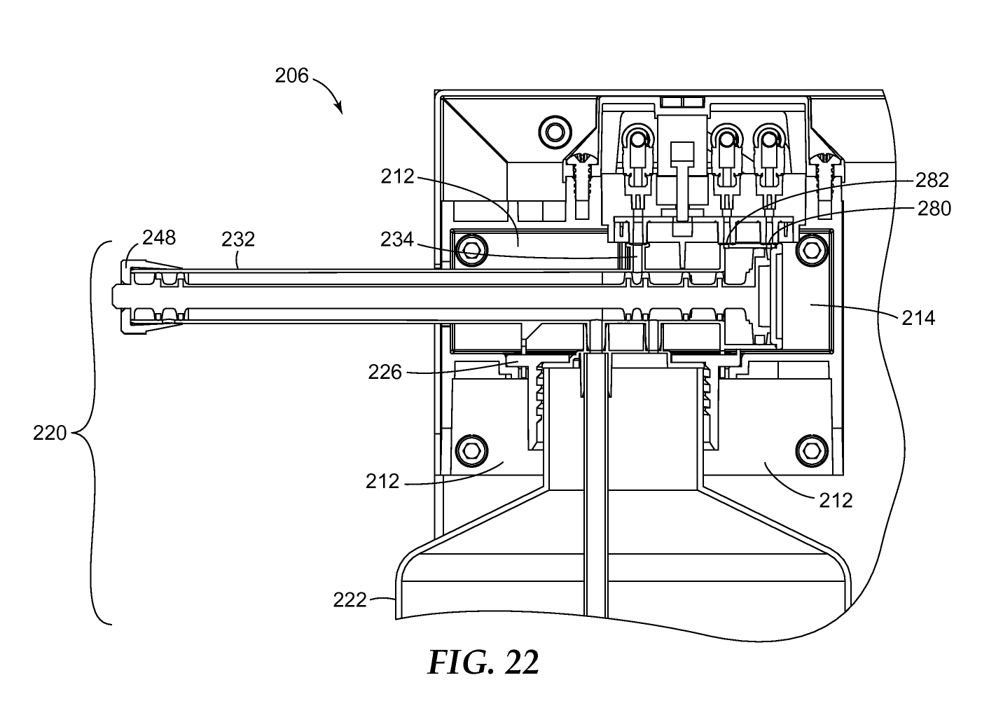

The coupler 206 includes a coupling mechanism 208 configured to receive and/or sealingly engage at least a portion of a dispensing assembly 220. In the embodiment shown in FIG. 14 and FIG. 17, the coupling mechanism can include a slotted mount 210 configured to be complementary to at least a portion of a dispensing assembly 220. In some embodiments, the coupling mechanism 208 can include a clamp configured to engage a portion of the dispensing assembly 220 and hold the dispensing assembly 220 in place while in use with the bench top system 200. In embodiments that include a clamp as a coupling mechanism 208, the clamp may be manually operated or, in some embodiments, actuated by fluid pressure from the bench top system 200. In embodiments in which the clamp is operated using pressure from the bench top system 200, the clamp can include a clamp/manifold assembly 212 that, when clamped, transmits pressure signals to the dispensing assembly 220. The clamp also can include a clamp actuator 214 that can supply clamping force to the clamp/manifold assembly 212. The complementary configuration of the coupler 206 and the dispensing assembly 220 is shown in greater detail in FIG. 22.

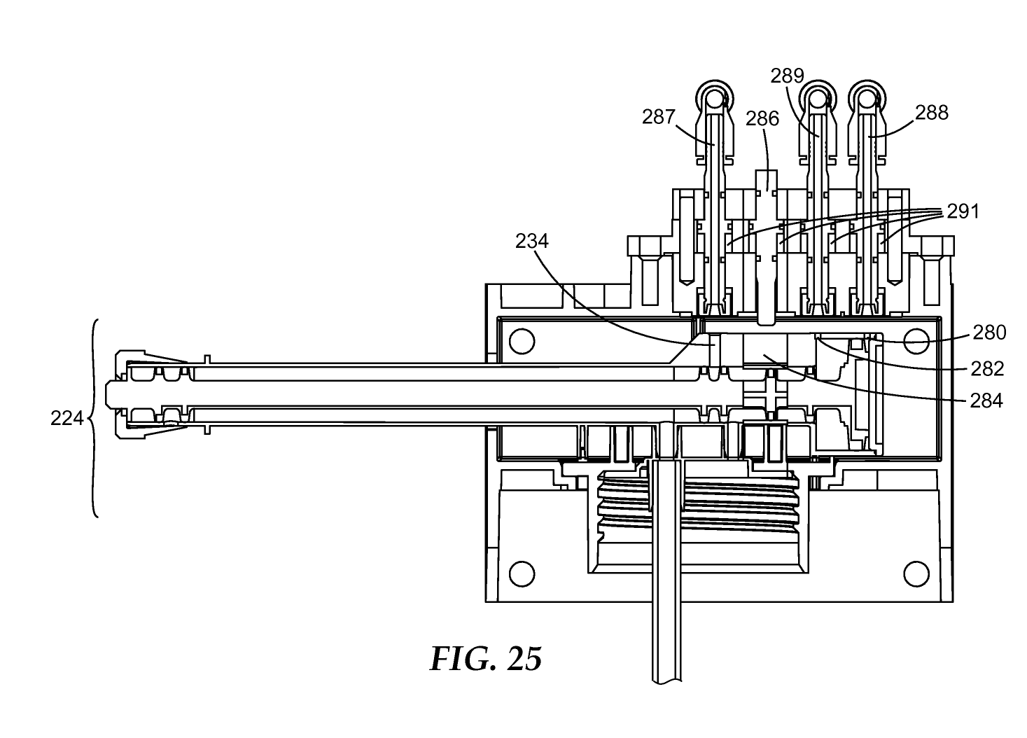

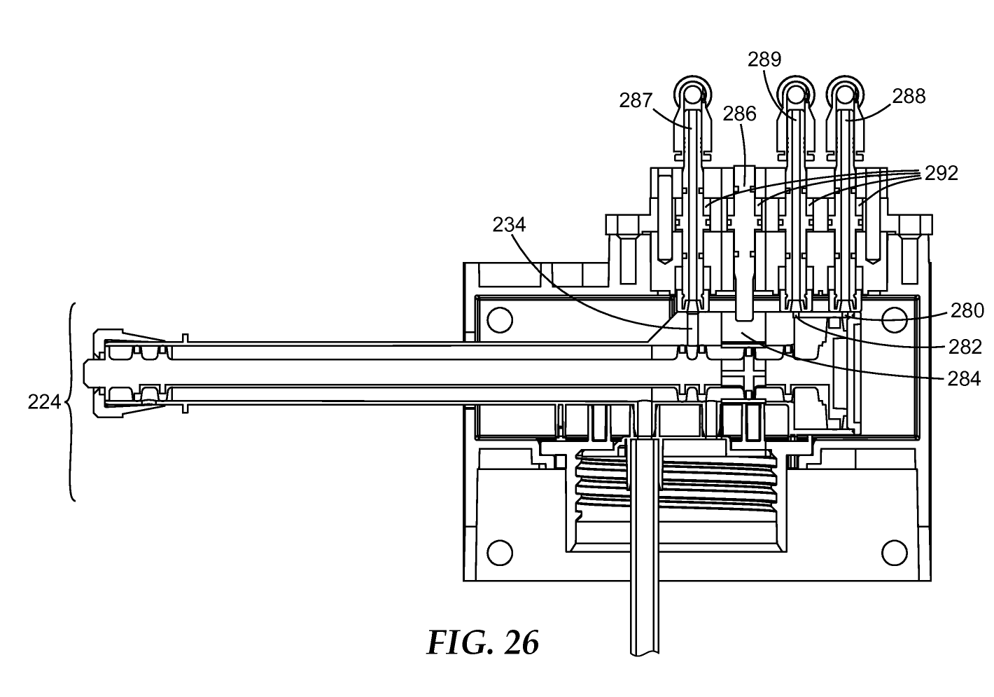

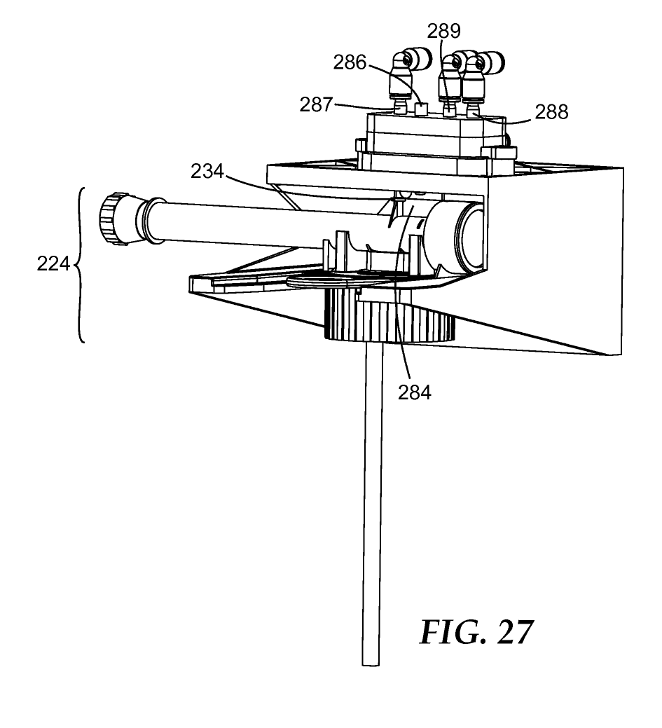

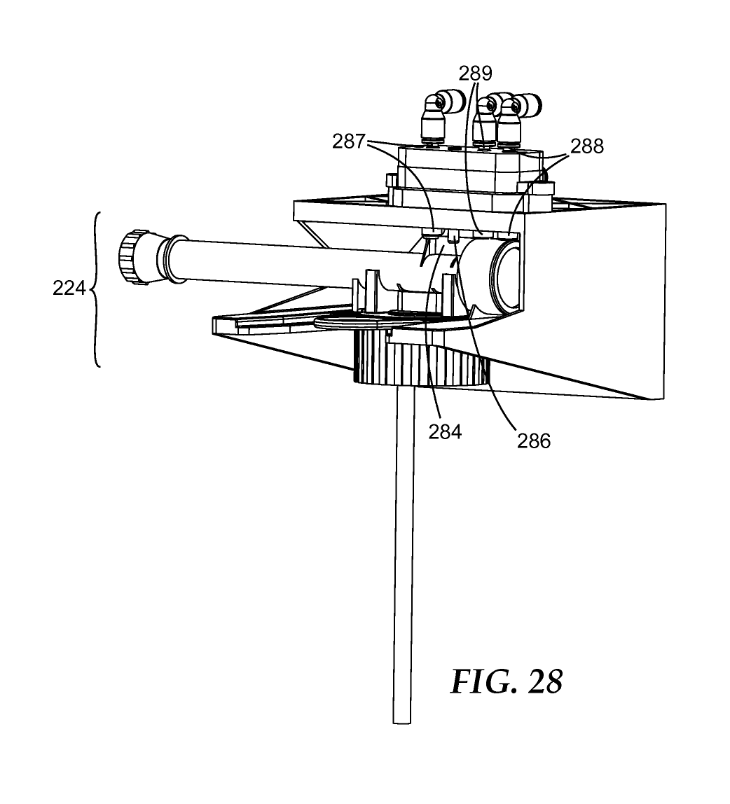

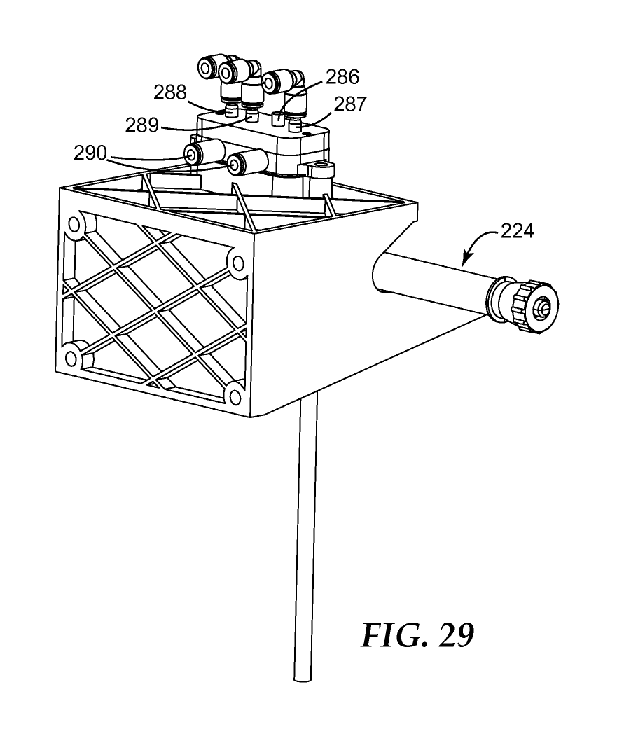

In some embodiments, shown in FIGS. 25-29, the coupler can include separate actuators 287, 288, and 289 that can separately engage with the cap and valve assembly 224 when the dispensing assembly 220 is positioned in the bench top device 200. Pressure delivered from the manifold assembly (291, FIG. 25; 292, FIG. 26) can control the movement of actuators 287, 288, and 289. Pressure may be delivered to the manifold assembly via one or more manifold inlets 290, shown in FIG. 29. FIG. 25 and FIG. 27 show the actuators 287, 288, and 289 unengaged with their counterpart structures (234, 280, and 282, respectively) of the cap and valve assembly 224. A pressure signal delivered to a first manifold portion 291 (i.e., an “up” signal) (shown in the cross-section of FIG. 25) can position the actuators to the positions shown in FIGS. 25, 27, and 29. A pressure signal delivered to a second manifold portion 292 (i.e., a “down” signal) (shown in the cross-section of FIG. 26) can reposition the actuators from the positions shown in FIGS. 25, 27, and 29 to the positions shown in FIG. 26 and FIG. 28.

In some embodiments, a single pressure signal delivered from the first and second manifold portions 291 and 292, respectively, can control all of the actuators, each of which can be moveable independently of the other actuators. That is, while the actuators 287, 288, and 289 are controlled by a single pressure signal within the first manifold portion 291, each actuator may move independently of the others to the extent necessary to engage their counterpart structures (234, 280, and 282, respectively) of the cap and valve assembly 244, as shown in FIG. 26 and FIG. 28. Likewise, a single signal within the second manifold 292 can reverse the movement of actuators 287, 288, and 289.

In some embodiments, the seal between the actuators 287, 288, and 289 their respective counterpart structures 234, 280, and 282 is provided by sealing members disposed on the engaging end of each actuator. In one embodiment, the sealing members are removable and replaceable. In one embodiment, the sealing members are removable and replaceable by hand (i.e., without the use of tools). In some embodiments, the sealing members are integral, such as being formed by an overmold.

The actuator 218 is configured to actuate a dispenser assembly 220, thereby allowing delivery of fluid pressure from the pressure outlet 204 to the dispenser assembly.

FIG. 14 shows additional optional components that can be a part of a conventional pressurized system. These conventional components include, for example, pressure sources 215A and 215B and safety valves 217A and 217B,

In use, a user manipulates the handle 138, which actuates the flow of pressure into the system. In some cases, the handle may correspond to the knob 132 (e.g., FIG. 1-3) or rotational handle 138 (e.g., FIG. 11) of a flow control device 102 as described above. Regardless of whether a flow control device 102 is involved, manipulating the handle introduces pressure into the bench top system 200. The pressure is transmitted to the pressure outlet 204 in the housing 202, where it may be further transmitted to a corresponding pressure inlet of a dispensing assembly 220 secured into the coupler 206. The pressure transmitted from the bench top system 200 to the dispensing assembly 220 in this way allows the user to controllably dispense fluid from the dispensing assembly 220.

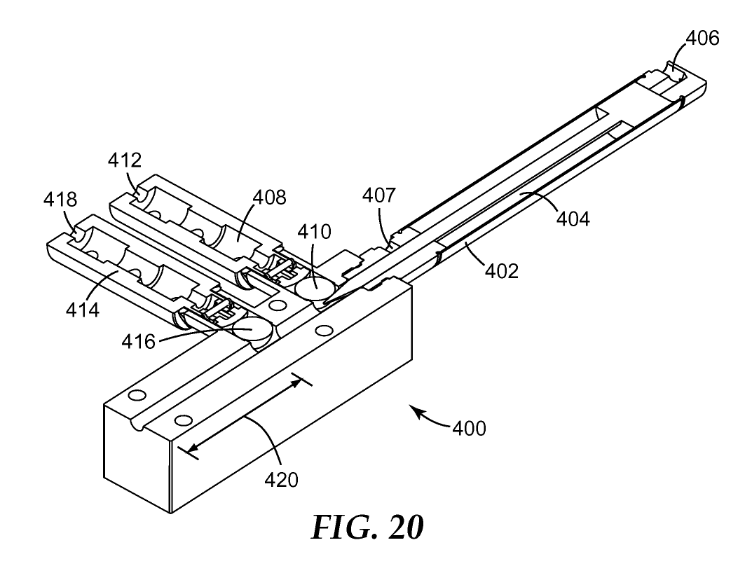

In some embodiments, one or both of the coupler 206 and the actuator 218 may be in fluid communication with a controller through which a user can control the function of the coupler 206 and/or the actuator 218. In some of these embodiments, the coupler may be in fluid communication with a first controller and the actuator may be in fluid communication with a second controller. In some of these embodiments, the first and second controllers may be components of a sequencer assembly 400 (FIG. 14, shown in detail in FIG. 20).

The sequencer assembly 400 can allow a user to control the timing and sequence of events that occur during a typical dispense cycle. In the absence of the sequencer assembly, if the user suddenly transition from a fast fill (i.e., high pressure) condition to a stop/valve closed condition, residual pressure could be stored in the fluid reservoir portion of a dispensing assembly. This residual pressure may then be released the next time that the dispensing assembly for the reservoir is used. The next user may be unaware that residual pressure is stored in the fluid reservoir and the unexpected release of the stored pressure may result in a fluid spill or other accidental mishap. To avoid residual pressure, one can close off pressure to the dispensing device 220 prior to releasing the dispensing device 220 from the coupler 206 of the bench top system 200. One way of achieving the proper sequence of these steps is to employ commercially available pneumatic logic blocks. These devices can, however, be costly. Thus, we have devised an alternative sequence assembly 400.

An exemplary sequencer assembly 400 is illustrated in FIG. 20. The sequencer assembly 400 includes a body wall 402 that defines a lumen 404. A first pressure inlet 406 provides fluid communication between the lumen 404 and a pressure source such as, for example, a work outlet 112 of a flow control device 102, described above. A second pressure inlet 407 provides fluid communication between the lumen 404 and a pressure source such as, for example, a sequencer assembly control valve 140 of a flow control device 102. The sequencer assembly 400 further includes a first sequencer control 408 that includes a first sequencer valve 410 and a first pressure outlet 412 that provides fluid communication between the first sequencer control 408 and a first output device, and a second sequencer control 414 that includes a second sequencer valve 416 and a second pressure outlet 418 that provides fluid communication between the second sequencer control 414 and a second output device. The sequencer assembly 400 also includes a sequencer core 424 slidably positioned within the lumen 404 and whose position in the lumen is controlled by the transmission of pressure into the lumen 404 through the pressure input 406.

The sequencer assembly 400 may be in fluid communication with a flow control device 102 as shown in FIG. 14. The flow control device 102 is in fluid communication with the bench top system coupler 206 and dispensing assembly 220 as described above. The flow control device 102 also is in fluid communication with the sequencer assembly. FIGS. 1-3 illustrate an embodiment of a flow control device 102 configured to provide fluid communication to more than one system component via a plurality of work outlets 112. FIG. 12 and FIG. 13 show embodiments configured to provide fluid communication to a sequencing assembly 400 through sequencer assembly control valve 140. Thus, actuation of the flow control device 102 not only transmits pressure to the dispensing assembly 220, but also transmits pressure to the sequencer assembly 400 through the first pressure inlet 406 and actuates sequencer core 424 (shown in FIG. 20).

In the embodiment shown in FIG. 20, as the sequencer core 424 is advanced in the lumen 404 as a result of pressure transmitted through the first pressure inlet 406, it first actuates the first sequencer valve 410. As the sequencer core 424 is advanced further, it eventually actuates the second sequencer valve 416. As the sequencer core 424 is advanced further along the overtravel distance 420, no additional actuation occurs. The overtravel distance 420 is used to time the phases of the “shut off” sequence when the dispensing of fluid is complete.

When dispensing the fluid is finished and the user returns the flow control device 102 actuator to the closed or “off” position, the flow control member 120 (e.g., a flow control core in the embodiment shown) actuates the sequencer assembly control valve 140, transmitting pressure from the flow control device 102, through the sequencer assembly control valve 140, and to the sequencer assembly lumen 404 through the second pressure inlet 407. (FIG. 13 and FIG. 14). This pressure retracts the sequencer core 424, first disengaging from the second sequencer valve 416, then disengaging from the first sequencer valve 410, thereby first closing off pressure to the second sequencer control 414, then closing off pressure to the first sequencer control 408. As pressure is closed off from each sequencer control, the supply of pressure to the first output device and second output device is disrupted and those output devices cease to function in sequence.

In one embodiment, the first output device may be a fluid pressure-driven clamp serving as a coupler 206 in a bench top fluid dispensing system 200 as shown in FIG. 11. The second output device in such an embodiment may be an actuator 218 as shown in FIG. 11. In such an embodiment, movement of the sequencer core 424 past the first sequencer valve 410 results in pressure being transmitted from the first sequencer control 408 through the first pressure outlet 412 and to the first output device—e.g., the fluid pressure-driven clamp, which clamps the dispensing assembly in place within the coupler 206 of the bench top system housing 202. As the sequencer core 424 continues to advance, it actuates the second sequencer valve 416, resulting in pressure being transmitted from the second sequencer control 414 through the second sequencer outlet 418 and to the second output device—e.g., the actuator 218.

When dispensing is complete and the sequencer core 424 begins its retraction, it first retracts along the overtravel distance 420. The travel time required for the sequencer core 424 to traverse the overtravel distance 420 provides idle time during which residual pressure introduced into the dispensing assembly can be vented before the sequencer core 424 disengages from the second sequencer valve, thereby disrupting the supply of pressure to, and shutting off, the actuator 218. As sequencer core 424 continues to retract, it disengages from the first sequencer valve 410, disrupting the supply of pressure to, and shutting off, the fluid pressure-driven clamp of the coupler 206, allowing the user to remove the dispensing device 220 from the bench top system 200. The amount of travel time provided in this manner is controlled, at least in part, by variable flow controls mounted to the sequencer actuator.

In some embodiments, the sequencer assembly can include a third sequencer control the include a third sequencer valve and a third pressure output that provides fluid communication between the third sequencer control and a third output device. The sequencing of de-energizing the system can work with three sequencer controls controlling three output devices in the same manner at that described in detail for the two sequencing control design. One can design the overtravel distance 420 and the space between sequencer controls to provide the proper timing delay of de-energizing the output devices.

Whether the fluid dispensing system is a bench top system or a hand held system, the system includes a dispensing assembly 220 that generally includes a fluid reservoir 222 and a cap and valve assembly 224. In the embodiments illustrated in the various Figures, the fluid reservoir 222 is illustrated as a bottle. However, the fluid reservoir 222 can be have any form suitable for containing a fluid such as, for example, a pouch, a bag, a box, a can, a canister, etc. One feature of, for example, the bench top system 200 described above is that it can be used in combination with a fluid reservoir 222 that need not have a defined shape—e.g., a bottle or canister having at least semi-rigid walls. Because the fluid reservoir 222 is secured into the bench top system 222 via a coupler 206, fluid can be dispensed from the fluid reservoir 222 while the fluid reservoir 222 is suspended by the cap and valve assembly 224 from the coupler 206 of the bench top system housing 202, as shown in FIG. 11. Accordingly, the fluid reservoir 222 need not possess rigid or semi-rigid structure to allow efficient, accurate, dispensing of fluid.

The cap and valve assembly 224 generally includes a cap 226 configured to sealingly engage with an opening on the fluid reservoir 222. Often, the sealing engagement between the fluid reservoir 222 and the cap 226 involves complementary threading that allows for a “screw cap”-type fit. Other coupling strategies are possible, however, including, for example, a clamp or a snap fitting. In some embodiments, such as those involving a cap and valve assembly having modular parts described in more detail below, the cap 226 may be configured so that the sealing engagement with the opening of the fluid reservoir 222 is nonreversible. The cap 226 also includes a pressure inlet 228 the provides fluid communication through the cap 226 to the interior of the fluid reservoir 222, and a flow inlet 230 in fluid communication with fluid contained in the fluid reservoir 222.

The cap and valve assembly 224 further includes an elongate member 232 that includes a pressure coupler 234, an outlet aperture 238, a lumen 236 providing fluid communication between the flow inlet 230 and the outlet aperture 238, a repositionable valve core 240 disposed within the lumen 236, and core control apertures 280 and 282. The pressure coupler 234 may be configured to align or otherwise provide fluid communication with the pressure outlet (204 or 304) of the fluid dispensing system (200 or 300, respectively). This alignment or other fluid communication allows delivery of pressure provided by the system to the fluid reservoir 222 for dispensing fluid. The pressure provided by the system through the pressure outlet (204 or 304) may be controlled by a user through the flow control device 102.

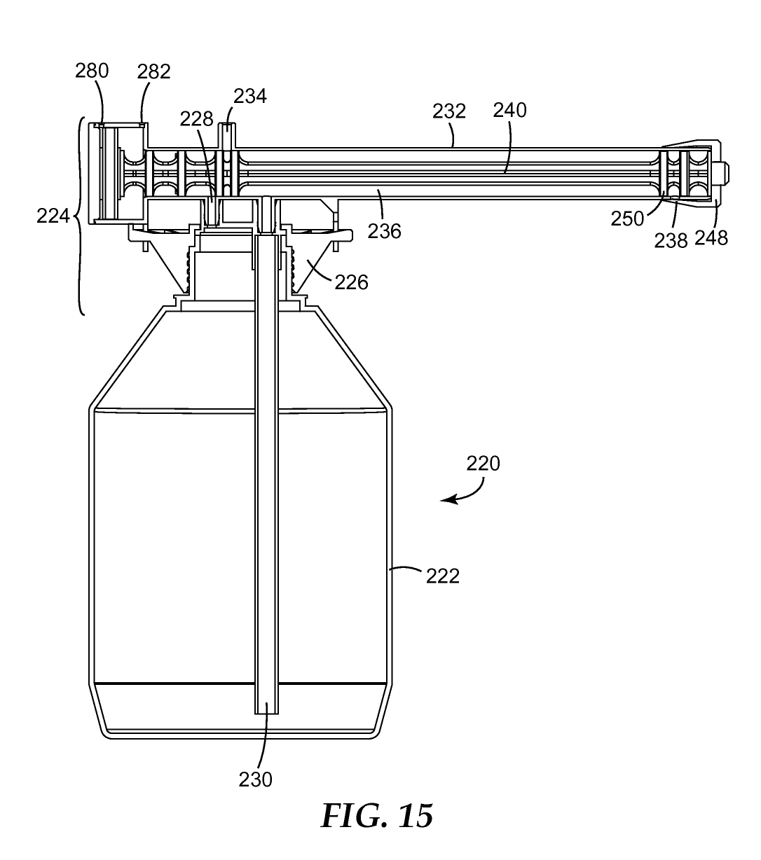

The repositionable valve core may be disposed in at least two positions. In a first position, illustrated in FIG. 15, the valve core 240 obstructs fluid communication between the pressure coupler 234 and the pressure inlet 228. In this position, the valve core 240 obstructs the application of pressure from the system into the fluid reservoir 222 and, therefore, obstructs the flow of fluid from the fluid reservoir 222, through the flow inlet 230, the lumen 236 of the elongate member 232, and out the outlet aperture 238.

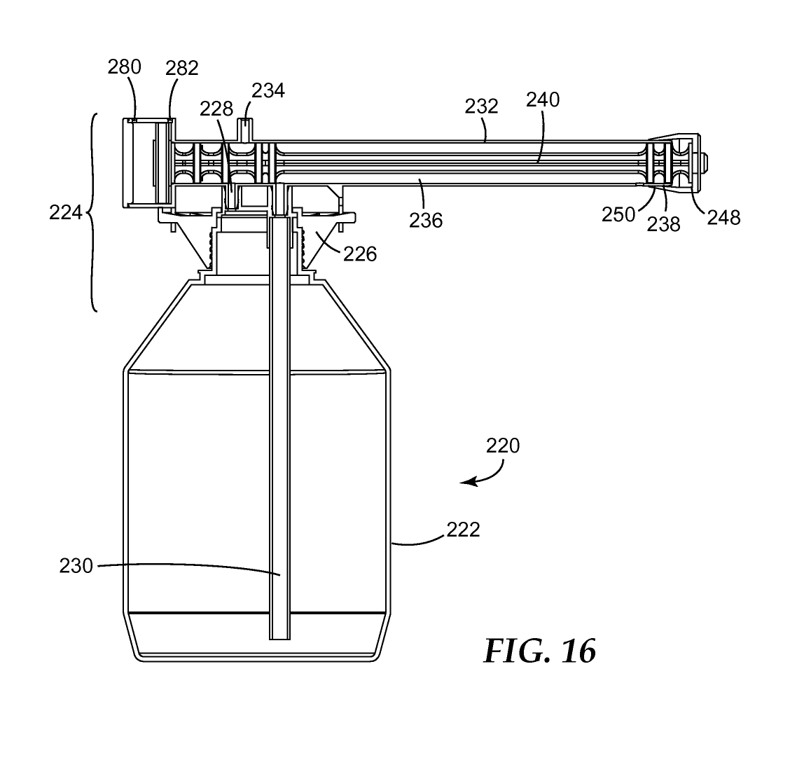

In a second position, however, illustrated in FIG. 16, the valve core 240 is actuated to provide fluid communication from the pressure coupler 234 to the pressure inlet 228, thereby providing pressure to the fluid reservoir 222. In this position, pressure transmitted to the fluid reservoir 222 can force fluid from the reservoir 222 out through the flow inlet 230, through the lumen 236 of the elongate member 232, and out the outlet aperture 238.

The repositionable valve core 240 may be repositioned by applying pressure through core control apertures 280 and 282. Pressure applied through core control aperture 280 repositions the repositionable valve core 240 forward—i.e., in the direction going from the first position to the second position described immediately above. Pressure applied through control aperture 282 repositions the repositionable valve core 240 back—i.e., in the direction going from the second position to the first position described immediately above. In this context, reference to the first position and second position illustrated in FIG. 15 and FIG. 16 is provided to illustrate the general direction of movement of the repositionable valve core 240. In use, pressure may be applied through the core control apertures 280 and 282 without fully reaching the first position and second position. In the second position, shown in FIG. 16, fluid communication between the pressure coupler 234 and the pressure inlet 228 is established so that dispensing pressure may be applied to the fluid in the reservoir 222.

In the embodiment illustrated in FIG. 26 and FIG. 28, in which actuators 287, 288, and 289 separately engage the cap and valve assembly 224, the actuators 287, 288, and 289 may be configured to align with the pressure coupler 234, core control aperture 280, and core control aperture 282, so that pressure may be delivered through the actuators to control dispensing of the fluid from the reservoir 222.

In some embodiments, the elongate member 232 may be constructed of material transparent enough to allow one to view contents of, for example, the lumen 236.

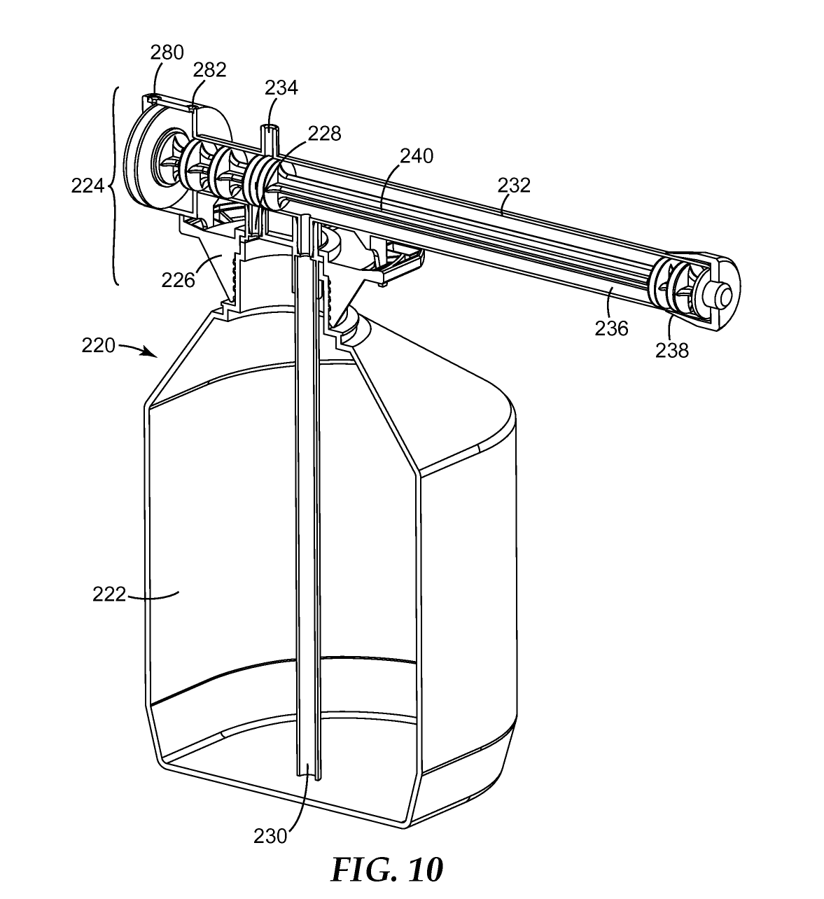

In a hand held system 300, as described above and illustrated in FIG. 19, the valve core 240 may be actuated into the second position by mechanical action of the actuator 318. In a bench top system 200, as described above and illustrated in FIG. 10, the valve core 240 may be actuated by a fluid pressure-driven actuator 218 (FIG. 11 and FIG. 14) controlled by a sequencer assembly 400 described above and illustrated in FIG. 14 and FIG. 20.

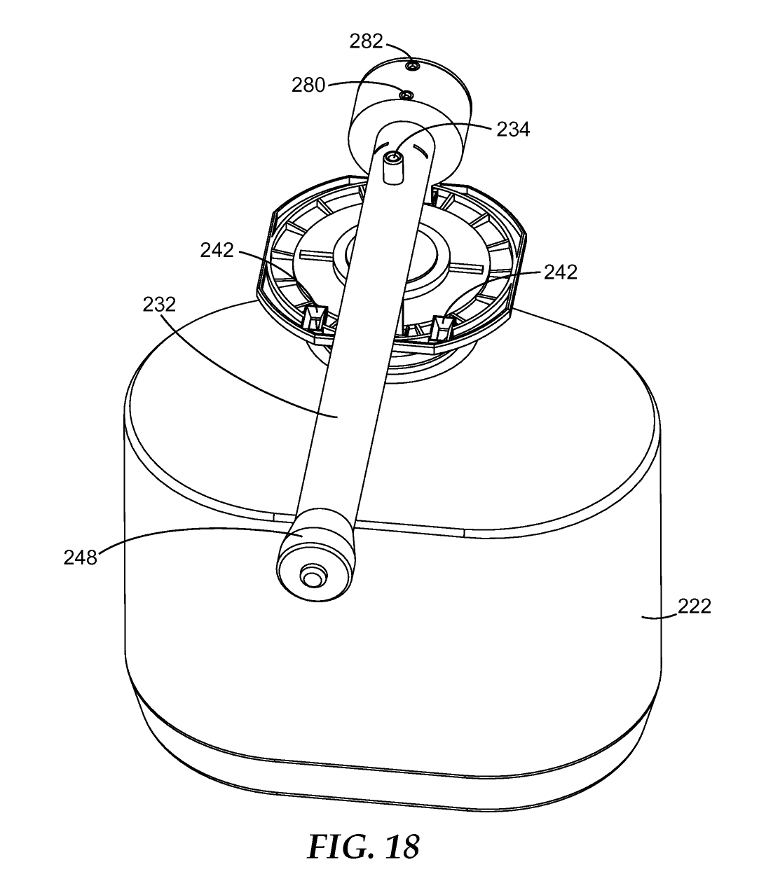

The cap and valve assembly 224 can further include a housing coupler 242 configured to be received and/or otherwise engaged by a coupler (206 or 306) on the housing (202 or 302) of the fluid dispensing system (200 or 300, respectively). In the context of a hand held system 300 as illustrated in FIG. 19, the housing coupler 242 may be as simple as slots configured to be engaged by clips 308 (FIG. 18). In the context of a bench top system 200, the housing coupler 242 can include one or more shoulders 244 configured to be received by slotted mount 210 (FIG. 17). In some embodiments, the housing coupler 242 can further include a positioning groove configured to engage a positioning nodule on the coupler 206 on the housing 202.

In some embodiments, the cap and valve assembly 224 can further include a flange 284 configure to engage with locking pin 286, as shown in FIGS. 25-29. In the embodiment shown in FIGS. 25-29, the locking pin 286 may be controlled by the manifold assembly 212 in a manner similar to the control of actuators 287, 288, and 289. FIG. 25, FIG. 27, and FIG. 29 show the locking pin 286 in a first position in which the locking pin 286 is not engaged with any portion of the cap and valve assembly 224. Upon application of a pressure signal, locking pin 286 moves to a second position shown in FIG. 26 and FIG. 28 in which the locking pin 286 engages with the flange 284 of the cap and valve assembly 224, locking the dispensing assembly 220 in place.

In some embodiments, the cap and valve assembly 224 can further include a repositionable tip cover 248 covering the end of the elongate member 232. In one position, the tip cover 248 can cover the outlet aperture 238, whereas in a second position, the tip cover can expose the outlet aperture 238. In contrast to other devices, the repositioning of the tip cover 248 can be independent of the repositioning of the valve core 240 and the corresponding transmission of pressure into the fluid reservoir 222. Consequently, repositioning the tip cover 248 to expose the outlet aperture does not necessarily result in dispensing fluid through the outlet aperture 238. Positioning the tip cover 248 to cover the outlet aperture 238 can clean the outlet aperture 238 of residual fluid remaining at the outlet aperture 238 after dispensing of fluid is complete. In some embodiments, the tip cover 248 may be rotatable around the long axis of the elongate member 232. Doing so may help limit accumulation of dried fluid on the portion of the tip cover 248 that covers the outlet aperture 238.

The tip cover 248 can be configured to be replaceable component. In some embodiments, it may be a single piece that is configured to slide over the end of the elongate member 232. In other cases, it may be produced as a two-part piece that may be, for example, snap fitted together over the end of the elongate member 232.

In some embodiments, the valve core 240 can further include a seal 250. The seal may be configured so that when the valve core 240 is positioned to provide dispensing of fluid, as is shown in FIG. 16, the seal 250 is distal to the outlet aperture 238, but when the valve core 240 is in the position shown in FIG. 15, the seal 250 is proximal to the outlet aperture 238. Thus, the seal 250 can prevent fluid communication between the outlet aperture 238 and the lumen 236, flow inlet 230, and/or fluid reservoir 222 in the event the tip cover 248 is not positioned to cover the outlet aperture 238. The seal 250 can therefore inhibit the inadvertent drying of fluid in the lumen 236 or the flow inlet 230 in between dispensing events such as, for example, during storage of the dispensing assembly 220.

In some embodiments, the cap and valve assembly 224 can further include a cap insert 252 configured to engage with a second fluid reservoir. The cap insert 252 may therefore allow one to use a single cap and valve assembly 224 with a series of different fluid reservoirs. Alternatively, since various manufacturers (e.g., paint manufacturers) use containers with varying cap sizes and/or, for example, thread pitch, the cap insert 252 may allow a shop, for example, to order a cap and valve assemblies with a single cap and use the cap insert 252 to adapt the cap and valve assembly 224 to fit a container provided by any particular manufacturer.

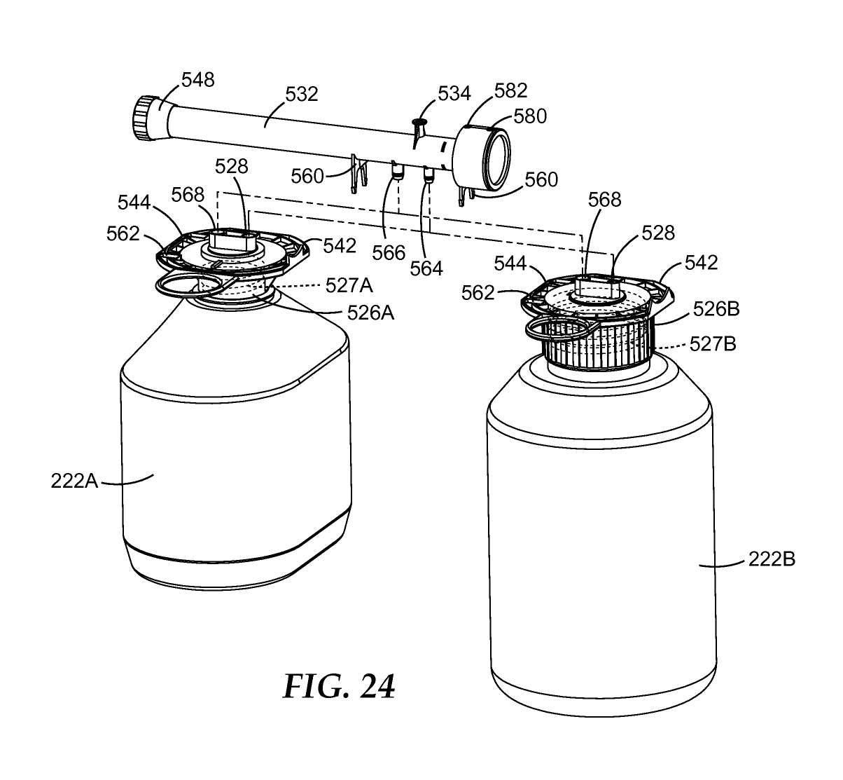

In some embodiments, the cap and valve assembly can include a modular cap component 526 and an elongate member component 532. That is, the cap and the elongate member may be configured to be detachable from one another so that a single cap component 526 may be used interchangeably with various elongate member designs. Similarly, a single elongate member component 532 may be used interchangeably with various cap designs, as illustrated in FIG. 24. The modular nature of such cap and valve assemblies can allow a user to, for example, replace only a portion of the cap and valve assembly and retain a portion that is still fit for further use. For example, an elongate member may become unusable because, for example, fluid (e.g., a paint component) may dry and/or cure in the lumen or outlet aperture. In such an instance, the cap may remain fully functional. The modular nature of the cap and valve assembly allows a user to replace the elongate member while retaining use of the still functional cap component. Likewise, a user can replace a nonfunctional cap component while retaining use of a still functional elongate member component.

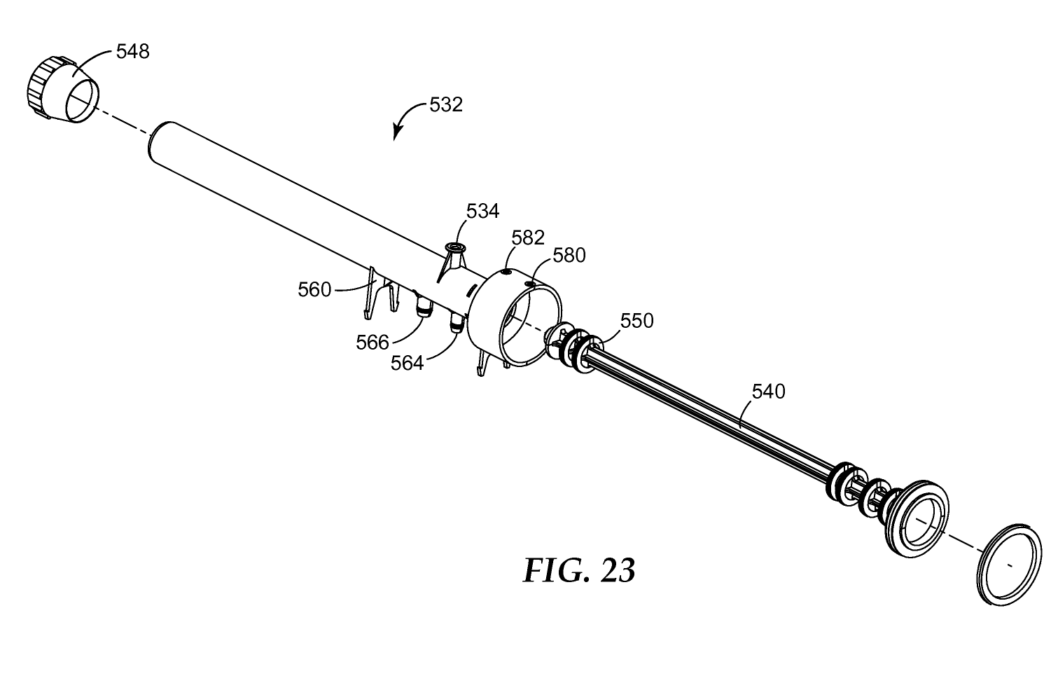

Thus, one can provide a kit that generally includes components such as those illustrated in FIG. 23 and FIG. 24. As shown in FIG. 24, a cap component 526 may be configured to sealingly engage with a fluid reservoir (222A and 222B) and an elongate member component 532, each of which is configured to couple with the other. As shown in FIG. 24, the cap component 526 can include a pressure inlet 528 configured to align with a pressure orifice 564 on the elongate member component 532 to facilitate the transmission of pressure from the elongate member component 532 to the cap component 526. Likewise, the elongate member component 532 can include a flow aperture 566 configured to align with a flow orifice 568 on the cap component 526 and provide fluid communication between the flow orifice 568 and the lumen of the elongate member component 532.

The coupling between the cap component 526 and the elongate member component 532 may be any suitable coupling that provides sufficient structural integrity for the assembled cap and valve assembly to functionally dispense a fluid, while offering the interchangeability of components. Suitable couplings can include, for example, snap fittings or press fittings. Thus, the elongate member component includes a coupling mechanism 560 configured to couple with a complementary coupling mechanism 562 on the cap component 526. In the embodiment shown in FIG. 24, the elongate member component 532 includes locking tabs as a coupling mechanism 560 configured to couple with slots as a coupling mechanism 562 on the cap component 526.

In addition to the coupler configured to couple with the modular elongate member component, the modular cap component 526 can include any one or more features of the various embodiments of the cap portion of the cap and valve assembly 224 described above including, for example, a housing coupler or a cap insert. Likewise, in addition to the coupler configured to couple with the modular cap component, the modular elongate member component 532 can include any one or more of the features of the various embodiments of the elongate member portion of the cap and valve assembly 224 described above including, for example, a tip cover 548 or a seal 550, as shown in FIG. 23, or construction from transparent material.

FIG. 24 also illustrates the interchangeability of the modular components. In the illustrated example, a single elongate member component 532 is configured to be used with cap components 526A and 526B adapted for use with two different fluid reservoirs 222A and 222B, respectively. Each cap component 526A and 526B is similarly configured to couple with a single design of an elongate member component 532. Each cap component 526A and 526B has similarly configured pressure inlets 528 and flow orifices 568 configured to align with the pressure orifice 564 and flow aperture 566 of the elongate member component 532. Each cap component also has similarly configured slots 562 for engaging the locking tabs 560 of the elongate member component 532.

Each cap component 526A and 526B also has a similarly configured housing coupler 542, including similarly configured shoulders 544 for engagement with a bench top system as described herein.

Each fluid reservoir 222A and 222B includes a differently sized and/or differently threaded screwcap-type neck. Thus, each of the cap components 526A and 526B includes a fluid reservoir coupler (527A and 527B, respectively) configured to sealingly engage with the neck of a particular design of fluid reservoir.

In the preceding description, particular embodiments may be described in isolation. Unless otherwise expressly specified that a particular embodiment may not be combined with another embodiment, any embodiment may be combined with one or more other compatible embodiments.

Similarly, for any method disclosed herein that includes discrete steps, the steps may be conducted in any feasible order. And, as appropriate, any combination of two or more steps may be conducted simultaneously.

The present invention is illustrated by the following examples. It is to be understood that the particular examples, materials, amounts, and procedures are to be interpreted broadly in accordance with the scope and spirit of the invention as set forth herein.

### EXAMPLES

### Example 1

A flow control device was connected as follows to monitor work pressure transmitted from the flow control device and the device is actuated: Pressurized air supply, pressure regulator (R374-01ALTE010, Parker Hannifin Corp., Cleveland, Ohio), flow control device, cable style pressure transducer (PX209-015G5V, Omegadyne, Inc., Sunbury, Ohio), and FLUKE 189 Datalogger (Fluke Corp., Everett, Wash.). The sensor exhibited a bias of 0.075V at zero pressure.

The pressure regulator was opened to full flow so that the flow control device governed work pressure transmitted to the pressure sensor. Starting in the fully closed “off” position, work pressure was monitored by the pressure sensor. The flow control device was actuated in linear increments of 0.025 inches. The measured work pressure as a function of actuation is shown in FIG. 20 (Controlled Bleed Flow Control).

Work pressure transmitted by the pressure regulator with the flow control device omitted is monitored. Starting with the pressure regulator in the fully closed “off” position, work pressure is monitored as the pressure regulator is actuated. FIG. 20 shows expected representative data (Conventional Flow Control).

### EXEMPLARY EMBODIMENTS

### Embodiment 1

A flow control device comprising:

a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and

a flow control member adapted to selectively occlude the bleed outlet;

wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area.

### Embodiment 2

The flow control device of Embodiment 1 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 3

The flow control device of Embodiment 2 wherein, in the forward position, the medial portion of the tip end sealingly engages the bleed outlet so that the tip end of the flow control core fully occludes the bleed outlet.

### Embodiment 4

The flow control device of Embodiment 2 or Embodiment 3 wherein, in the retracted position, the tip end of the flow control core does not occlude the bleed outlet.

### Embodiment 5

The flow control device of any preceding Embodiment wherein the inlet is in fluid communication with a source of fluid pressure.

### Embodiment 6

The flow control device of Embodiment 5 wherein the bleed outlet is in fluid communication with a fluid reservoir.

### Embodiment 7

The flow control device of Embodiment 6 wherein the fluid reservoir is in fluid communication with the source of fluid pressure, forming a closed circuit.

### Embodiment 8

The flow control device of any preceding Embodiment wherein the work outlet is in fluid communication with a work apparatus.

### Embodiment 9

The flow control device of Embodiment 8 wherein the work apparatus comprises a liquid dispenser.

### Embodiment 10

The flow control device of any preceding Embodiment wherein the unoccluded bleed flow area is greater than the work outlet flow area.

### Embodiment 11

The flow control device of Embodiment 10 wherein the unoccluded bleed flow area is greater than the work outlet flow area by a ratio of at least 5:1.

### Embodiment 12

The flow control device of any preceding Embodiment wherein moving from the second position to the first position comprises moving the flow control member.

### Embodiment 13

The flow control device of any preceding Embodiment wherein moving from the second position to the first position comprises moving the body.

### Embodiment 14

A method comprising:

providing a flow control device comprising:
a body comprising a body wall that defines a chamber, the body wall comprising an inlet in fluid communication with the chamber, a work outlet comprising a work outlet flow area in fluid communication with the chamber, and a bleed outlet comprising a unoccluded bleed flow area in fluid communication with the chamber; and
a flow control member adapted to selectively occlude the bleed outlet; and

moving the flow control member between
(i) a second position wherein the flow control member at least partially occludes the bleed outlet to create a second bleed flow area; and
(ii) a first position wherein the flow control member occludes the bleed outlet to a smaller degree than when in the second position to create a first bleed flow area that is greater than the second bleed flow area.

### Embodiment 15

The method of Embodiment 14 further comprising:

introducing a pressurized fluid to the chamber through the inlet;

wherein as the flow control member is moved from the first position to the second position, fluid pressure through the work outlet increases without a spike from zero pressure.

### Embodiment 16

The method of any of Embodiments 14 or 15 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and the first position comprising a retracted position wherein the tip of end of the flow control core occludes the bleed outlet to a smaller degree than when in the forward position to create a first bleed flow area that is greater than the second bleed flow area.

### Embodiment 17

A method comprising:

providing a flow control device comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and

introducing a pressurized fluid to the chamber through the inlet to establish a first ratio of fluid flow through the bleed outlet relative to the work outlet;

reducing the unoccluded bleed flow area to a second bleed flow area to establish a second ratio of fluid flow through the bleed outlet relative to the work outlet, the second ratio being less than the first ratio.

### Embodiment 18

A system for dispensing a fluid, the system comprising:

a housing comprising a coupler, a pressure outlet, and an actuator; and

a flow control device in controllable communication with the actuator and in fluid communication with the pressure outlet, the flow control device comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and
a flow control member adapted to selectively occlude the bleed outlet;
wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area; and

a dispenser assembly comprising:
a fluid reservoir, and
a cap and valve assembly coupled to the housing via the coupler.

### Embodiment 19

The system of Embodiment 18 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 20

A device for dispensing fluid from a fluid reservoir comprising a coupler, the device comprising:

a housing comprising:
a flow control device in fluid communication with a pressure source and comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and
a flow control member adapted to selectively occlude the bleed outlet;
wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area; and
a pressure outlet in fluid communication with the flow control device;
an actuator engaged with the flow control core of the flow control device; and
a coupler configured to engage a dispenser assembly.

### Embodiment 21

The device of Embodiment 20 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 22

The device of any of Embodiments 20-21 wherein the coupler comprises a clip configured to engage a cap and valve assembly.

### Embodiment 23

An apparatus for dispensing fluid, the apparatus comprising:

a housing that comprises:
a coupler comprising a coupling mechanism configured to sealingly engage at least a portion of a dispenser assembly;
a pressure outlet in fluid communication with a pressure source and configured provide fluid communication with a pressure inlet on the dispenser assembly; and
an actuator configured to actuate a dispenser assembly, thereby delivering pressure to the dispenser assembly from the pressure outlet.

### Embodiment 24

The apparatus of Embodiment 23 wherein the coupling mechanism comprises a clamp configured to engage a coupling platform of the dispenser assembly.

### Embodiment 25

The apparatus of Embodiment 23 or Embodiment 24 wherein the coupler is in fluid communication with a first controller.

### Embodiment 26

The apparatus of any of Embodiments 23-25 wherein the actuator is in fluid communication with a second controller.

### Embodiment 27

The apparatus of Embodiment 26 wherein the first controller and second controller are controlled by a sequencer assembly.

### Embodiment 28

The apparatus of any of Embodiments 23-27 further comprising a flow control device in fluid communication with one or more of: the coupler, the actuator, and the pressure outlet;

the flow control device comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and
a flow control member adapted to selectively occlude the bleed outlet;
wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area.

### Embodiment 29

The apparatus of Embodiment 28 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 30

The apparatus of any of Embodiments 28-29 wherein fluid communication between the flow control device and one or more of the coupler and the actuator comprises fluid communication with an intervening sequencer assembly.

### Embodiment 31

A sequencer assembly comprising:

a body comprising:
a body wall that defines a lumen,
a pressure inlet through the body wall that provides fluid communication between the lumen and a pressure source,
a first sequencer control comprising a first sequencer valve and a first pressure outlet providing fluid communication between the first sequencer control and a first output device, and
a second sequencer control comprising a second sequencer valve and a second pressure outlet providing fluid communication between the second sequencer control and a second output device;

a sequencer core slidably positioned in the lumen, wherein in a first position the sequencer core actuates neither the first sequencer valve nor the second sequencer valve, in a second position the sequencer core actuates both the first sequencer valve and the second sequencer valve, and in an intermediate position between the first position and the second position, the sequencer core actuates the first sequencer valve but not the second sequencer valve.

### Embodiment 32

The sequencer assembly of Embodiment 31 wherein actuating the first sequencer valve releases pressure through the first pressure outlet that actuates the first output device.

### Embodiment 33

The sequencer assembly of Embodiment 32 wherein actuating the second sequencer valve releases pressure through the second pressure outlet that actuates the second output device.

### Embodiment 34

The sequencer assembly of Embodiment 33 wherein moving the sequencer core from the first position to the second position actuates the first sequencer valve and, after a delay, actuates the second sequencer valve.

### Embodiment 35

The sequencer assembly of Embodiment 34 wherein the delay in actuating the second sequencer valve is a function of the distance between the first sequencer valve and the second sequencer valve.

### Embodiment 36

The sequencer assembly of Embodiment 35 wherein the delay in actuating the second sequencer valve is a function of the speed at which the sequencer core is moved from the first position to the second position.

### Embodiment 37

The sequencer assembly of any preceding Embodiment wherein moving the sequencer core from the second position to the first position first de-actuates the second sequencer valve and then de-actuates the first sequencer valve.

### Embodiment 38

The sequencer assembly of Embodiment 37 wherein the second position comprises an overtravel distance such that a time delay exists between initiating moving the sequencer core from the second position to the first position and de-actuating the second sequencer valve.

### Embodiment 39

The sequencer assembly of any preceding Embodiment comprising at least a third sequencer control comprising a third sequencer valve and a third pressure outlet providing fluid communication between the third sequencer control and a third output device.

### Embodiment 40

A method of dispensing a fluid, the method comprising:

providing the system of any of Embodiments 18 or 19; and
actuating the actuator.

### Embodiment 41

A method of dispensing a fluid, the method comprising:

providing the device of any of Embodiments 20-22; and
actuating the actuator.

### Embodiment 42

A method for dispensing a fluid, the method comprising:

providing the apparatus of any one of Embodiments 23-30; and
actuating the actuator.

### Embodiment 43

The method of any one of Embodiments 40-42 wherein the fluid comprises a liquid.

### Embodiment 44

The method of any one of Embodiments 40-43 wherein the fluid comprises a paint component.

### Embodiment 45

A method of delivering a controlled increased air pressure, the method comprising:

providing an apparatus that comprises an actuator in control of a flow control device, the flow control device comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and
a flow control member adapted to selectively occlude the bleed outlet;
wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area; and

actuating the actuator such that as the flow control core is moved from the retracted position to the forward position, pressure through the work outlet increases without a spike from zero pressure.

### Embodiment 46

The method of Embodiment 45 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 47

A cap and valve assembly for use with a system comprising a housing and a fluid reservoir comprising a coupler, the cap and valve assembly comprising:

a cap configured to sealingly engage with the fluid reservoir coupler and comprising a pressure inlet and a flow inlet; and

an elongate member comprising a pressure coupler, a lumen, an outlet aperture, and a repositionable valve core wherein, in a first position:
the lumen provides fluid communication between the pressure coupler and the pressure inlet, and
the elongate member comprises a flow path that provides fluid communication between the flow inlet and the outlet aperture, and
in a second position, fluid communication between the pressure coupler and the pressure inlet is disrupted.

### Embodiment 48

The cap and valve assembly of Embodiment 47 further comprising a housing coupler.

### Embodiment 49

The cap and valve assembly of Embodiment 48 wherein the housing coupler comprises:

a shoulder configured to be received by a mounting slot on the system housing; and

a positioning groove configured to engage a positioning nodule on the system housing.

### Embodiment 50

The cap and valve assembly of any one of Embodiments 47-49 further comprising:

a repositionable tip cover wherein, in a first position, the tip cover covers the outlet aperture and, in a second position, uncovers at least a portion of the outlet aperture.

### Embodiment 51

The cap and valve assembly of Embodiment 50 wherein repositioning the tip cover from the second position to the first position cleans the outlet aperture.

### Embodiment 52

The cap and valve assembly of Embodiment 51 configured so that the tip cap can be positioned to uncover the outlet aperture independent of providing fluid communication between the pressure coupler and the pressure inlet.

### Embodiment 53

The cap and valve assembly of any one of Embodiments 47-52 wherein the valve core further comprises at least one seal that, when the valve core is in the second position, is proximal to the outlet aperture and when the valve core is in the first position, the seal is distal to the outlet aperture.

### Embodiment 54

The cap and valve assembly of Embodiment 53 wherein, when the valve core is in the second position, the seal at least partially obstructs the flow path.

### Embodiment 55

The cap and valve assembly of any one of Embodiments 47-54 further comprising a cap insert configured to sealing engage with a second fluid reservoir coupler.

### Embodiment 56

The cap and valve assembly of any one of Embodiments 47-55 wherein the elongate member is detachable.

### Embodiment 57

The cap and valve assembly of any one of Embodiments 47-56 wherein the elongate member is sufficiently transparent that contents of the lumen are visible.

### Embodiment 58

A kit comprising:

a cap configured to sealingly engage with a fluid reservoir comprising a fluid, the cap comprising a pressure inlet, a flow orifice, and a coupler; and

an elongate member comprising:
a coupler configured to couple with the cap coupler,
a pressure coupler configured to couple with a pressure source,
a lumen,
a pressure orifice configured to align with the cap pressure inlet,
an outlet aperture,
a flow aperture configured to align with the cap flow orifice, and
a repositionable valve core wherein, in a first position:
   the lumen and pressure orifice provide fluid communication between the pressure coupler and the cap pressure inlet, and
   the elongate member comprises a flow path that provides fluid communication between the flow orifice and the outlet aperture, and
   in a second position, fluid communication between the pressure coupler and the cap pressure inlet is disrupted.

### Embodiment 59

The kit of Embodiment 58 wherein the valve core further comprises at least one seal that, when the valve core is in the second position, is proximal to the outlet aperture and when the valve core is in the first position, the seal is distal to the outlet aperture.

### Embodiment 60

The kit of Embodiment 58 or Embodiment 59 wherein the cap further comprises a housing coupler.

### Embodiment 61

The kit of any one of Embodiments 58-60 further comprising a repositionable tip cover wherein, in a first position, the tip cover covers the outlet aperture and, in a second position, uncovers at least a portion of the outlet aperture.

### Embodiment 62

The kit of any one of Embodiments 58-61 further comprising a cap insert configured to sealingly engage with a second fluid reservoir.

### Embodiment 63

The kit of any one of claims 58-62 comprising a plurality of elongate members configured to be interchangeably usable with the cap.

### Embodiment 64

The kit of any one of claims 58-63 comprising a plurality of caps configured to be interchangeably usable with the elongate member.

### Embodiment 65

A flow control device comprising:

a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and

a flow control member adapted to selectively occlude the bleed outlet;

wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area.

### Embodiment 66

The flow control device of Embodiment 65 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 67

The flow control device of Embodiment 66 wherein, in the forward position, the medial portion of the tip end sealingly engages the bleed outlet so that the tip end of the flow control core fully occludes the bleed outlet.

### Embodiment 68

The flow control device of Embodiment 66 or Embodiment 67 wherein, in the retracted position, the tip end of the flow control core does not occlude the bleed outlet.

### Embodiment 69

The flow control device of any preceding Embodiment wherein the inlet is in fluid communication with a source of fluid pressure.

### Embodiment 70

The flow control device of Embodiment 69 wherein the bleed outlet is in fluid communication with a fluid reservoir.

### Embodiment 71

The flow control device of Embodiment 70 wherein the fluid reservoir is in fluid communication with the source of fluid pressure, forming a closed circuit.

### Embodiment 72

The flow control device of any preceding Embodiment wherein the work outlet is in fluid communication with a work apparatus.

### Embodiment 73

The flow control device of Embodiment 72 wherein the work apparatus comprises a liquid dispenser.

### Embodiment 74

The flow control device of any preceding Embodiment wherein the unoccluded bleed flow area is greater than the work outlet flow area.

### Embodiment 75

The flow control device of Embodiment 74 wherein the unoccluded bleed flow area is greater than the work outlet flow area by a ratio of at least 5:1.

### Embodiment 76

The flow control device of any preceding Embodiment wherein moving from the second position to the first position comprises moving the flow control member.

### Embodiment 77

The flow control device of any preceding Embodiment wherein moving from the second position to the first position comprises moving the body.

### Embodiment 78

A method comprising:

providing a flow control device comprising:
a body comprising a body wall that defines a chamber, the body wall comprising an inlet in fluid communication with the chamber, a work outlet comprising a work outlet flow area in fluid communication with the chamber, and a bleed outlet comprising a unoccluded bleed flow area in fluid communication with the chamber; and
a flow control member adapted to selectively occlude the bleed outlet; and
   moving the flow control member between

(i) a second position wherein the flow control member at least partially occludes the bleed outlet to create a second bleed flow area; and
(ii) a first position wherein the flow control member occludes the bleed outlet to a smaller degree than when in the second position to create a first bleed flow area that is greater than the second bleed flow area.

### Embodiment 79

The method of Embodiment 78 further comprising:

introducing a pressurized fluid to the chamber through the inlet;
wherein as the flow control member is moved from the first position to the second position, fluid pressure through the work outlet increases without a spike from zero pressure.

### Embodiment 80

The method of any of Embodiments 78 or 79 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and the first position comprising a retracted position wherein the tip of end of the flow control core occludes the bleed outlet to a smaller degree than when in the forward position to create a first bleed flow area that is greater than the second bleed flow area.

### Embodiment 81

A method comprising:

providing a flow control device comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and

introducing a pressurized fluid to the chamber through the inlet to establish a first ratio of fluid flow through the bleed outlet relative to the work outlet;

reducing the unoccluded bleed flow area to a second bleed flow area to establish a second ratio of fluid flow through the bleed outlet relative to the work outlet, the second ratio being less than the first ratio.

### Embodiment 82

A system for dispensing a fluid, the system comprising:

a housing comprising a coupler, a pressure outlet, and an actuator; and

a flow control device in controllable communication with the actuator and in fluid communication with the pressure outlet, the flow control device comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and
a flow control member adapted to selectively occlude the bleed outlet;
wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area; and

a dispenser assembly comprising:
a fluid reservoir, and
a cap and valve assembly coupled to the housing via the coupler.

### Embodiment 83

The system of Embodiment 82 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 84

A device for dispensing fluid from a fluid reservoir comprising a coupler, the device comprising:

a housing comprising:
a flow control device in fluid communication with a pressure source and comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and
a flow control member adapted to selectively occlude the bleed outlet;
wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area; and
a pressure outlet in fluid communication with the flow control device;
an actuator engaged with the flow control core of the flow control device; and
a coupler configured to engage a dispenser assembly.

### Embodiment 85

The device of Embodiment 84 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 86

The device of any of Embodiments 84-85 wherein the coupler comprises a clip configured to engage a cap and valve assembly.

### Embodiment 87

An apparatus for dispensing fluid, the apparatus comprising:

a housing that comprises:
a coupler comprising a coupling mechanism configured to sealingly engage at least a portion of a dispenser assembly;
a pressure outlet in fluid communication with a pressure source and configured provide fluid communication with a pressure inlet on the dispenser assembly; and
an actuator configured to actuate a dispenser assembly, thereby delivering pressure to the dispenser assembly from the pressure outlet.

### Embodiment 88

The apparatus of Embodiment 87 wherein the coupling mechanism comprises a clamp configured to engage a coupling platform of the dispenser assembly.

### Embodiment 89

The apparatus of Embodiment 87 or Embodiment 88 wherein the coupler is in fluid communication with a first controller.

### Embodiment 90

The apparatus of any of Embodiments 87-89 wherein the actuator is in fluid communication with a second controller.

### Embodiment 91

The apparatus of Embodiment 90 wherein the first controller and second controller are controlled by a sequencer assembly.

### Embodiment 92

The apparatus of any of Embodiments 87-91 further comprising a flow control device in fluid communication with one or more of: the coupler, the actuator, and the pressure outlet;

the flow control device comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and
a flow control member adapted to selectively occlude the bleed outlet;
wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area.

### Embodiment 93

The apparatus of Embodiment 92 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 94

The apparatus of any of Embodiments 92-93 wherein fluid communication between the flow control device and one or more of the coupler and the actuator comprises fluid communication with an intervening sequencer assembly.

### Embodiment 95

A sequencer assembly comprising:

a body comprising:
a body wall that defines a lumen,
a pressure inlet through the body wall that provides fluid communication between the lumen and a pressure source,
a first sequencer control comprising a first sequencer valve and a first pressure outlet providing fluid communication between the first sequencer control and a first output device, and
a second sequencer control comprising a second sequencer valve and a second pressure outlet providing fluid communication between the second sequencer control and a second output device;

a sequencer core slidably positioned in the lumen, wherein in a first position the sequencer core actuates neither the first sequencer valve nor the second sequencer valve, in a second position the sequencer core actuates both the first sequencer valve and the second sequencer valve, and in an intermediate position between the first position and the second position, the sequencer core actuates the first sequencer valve but not the second sequencer valve.

### Embodiment 96

The sequencer assembly of Embodiment 95 wherein actuating the first sequencer valve releases pressure through the first pressure outlet that actuates the first output device.

### Embodiment 97

The sequencer assembly of Embodiment 96 wherein actuating the second sequencer valve releases pressure through the second pressure outlet that actuates the second output device.

### Embodiment 98

The sequencer assembly of Embodiment 97 wherein moving the sequencer core from the first position to the second position actuates the first sequencer valve and, after a delay, actuates the second sequencer valve.

### Embodiment 99

The sequencer assembly of Embodiment 98 wherein the delay in actuating the second sequencer valve is a function of the distance between the first sequencer valve and the second sequencer valve.

### Embodiment 100

The sequencer assembly of Embodiment 99 wherein the delay in actuating the second sequencer valve is a function of the speed at which the sequencer core is moved from the first position to the second position.

### Embodiment 101

The sequencer assembly of any preceding Embodiment wherein moving the sequencer core from the second position to the first position first de-actuates the second sequencer valve and then de-actuates the first sequencer valve.

### Embodiment 102

The sequencer assembly of Embodiment 101 wherein the second position comprises an overtravel distance such that a time delay exists between initiating moving the sequencer core from the second position to the first position and de-actuating the second sequencer valve.

### Embodiment 103

The sequencer assembly of any preceding Embodiment comprising at least a third sequencer control comprising a third sequencer valve and a third pressure outlet providing fluid communication between the third sequencer control and a third output device.

### Embodiment 104

A method of dispensing a fluid, the method comprising:

providing the system of any of Embodiments 82 or 83; and
actuating the actuator.

### Embodiment 105

A method of dispensing a fluid, the method comprising:

providing the device of any of Embodiments 84-86; and
actuating the actuator.

### Embodiment 106

A method for dispensing a fluid, the method comprising:

providing the apparatus of any one of Embodiments 87-94; and
actuating the actuator.

### Embodiment 107

The method of any one of Embodiments 104-106 wherein the fluid comprises a liquid.

### Embodiment 108

The method of any one of Embodiments 104-107 wherein the fluid comprises a paint component.

### Embodiment 109

A method of delivering a controlled increased air pressure, the method comprising:

providing an apparatus that comprises an actuator in control of a flow control device, the flow control device comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and
a flow control member adapted to selectively occlude the bleed outlet;
wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area; and

actuating the actuator such that as the flow control core is moved from the retracted position to the forward position, pressure through the work outlet increases without a spike from zero pressure.

### Embodiment 110

The method of Embodiment 109 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 111

A cap and valve assembly for use with a system comprising a housing and a fluid reservoir comprising a coupler, the cap and valve assembly comprising:

a cap configured to sealingly engage with the fluid reservoir coupler and comprising a pressure inlet and a flow inlet; and

an elongate member comprising a pressure coupler, a lumen, an outlet aperture, and a repositionable valve core wherein, in a first position:
the lumen provides fluid communication between the pressure coupler and the pressure inlet, and
the elongate member comprises a flow path that provides fluid communication between the flow inlet and the outlet aperture, and
in a second position, fluid communication between the pressure coupler and the pressure inlet is disrupted.

### Embodiment 112

The cap and valve assembly of Embodiment 111 further comprising a housing coupler.

### Embodiment 113

The cap and valve assembly of Embodiment 112 wherein the housing coupler comprises:

a shoulder configured to be received by a mounting slot on the system housing; and

a positioning groove configured to engage a positioning nodule on the system housing.

### Embodiment 114

The cap and valve assembly of any one of Embodiments 111-113 further comprising:

a repositionable tip cover wherein, in a first position, the tip cover covers the outlet aperture and, in a second position, uncovers at least a portion of the outlet aperture.

### Embodiment 115

The cap and valve assembly of Embodiment 114 wherein repositioning the tip cover from the second position to the first position cleans the outlet aperture.

### Embodiment 116

The cap and valve assembly of Embodiment 115 configured so that the tip cap can be positioned to uncover the outlet aperture independent of providing fluid communication between the pressure coupler and the pressure inlet.

### Embodiment 117

The cap and valve assembly of any one of Embodiments 111-116 wherein the valve core further comprises at least one seal that, when the valve core is in the second position, is proximal to the outlet aperture and when the valve core is in the first position, the seal is distal to the outlet aperture.

### Embodiment 118

The cap and valve assembly of Embodiment 117 wherein, when the valve core is in the second position, the seal at least partially obstructs the flow path.

### Embodiment 119

The cap and valve assembly of any one of Embodiments 111-118 further comprising a cap insert configured to sealing engage with a second fluid reservoir coupler.

### Embodiment 120

The cap and valve assembly of any one of Embodiments 111-119 wherein the elongate member is detachable.

### Embodiment 121

The cap and valve assembly of any one of Embodiments 111-120 wherein the elongate member is sufficiently transparent that contents of the lumen are visible.

### Embodiment 122

A kit comprising:

a cap configured to sealingly engage with a fluid reservoir comprising a fluid, the cap comprising a pressure inlet, a flow orifice, and a coupler; and

an elongate member comprising:
a coupler configured to couple with the cap coupler,
a pressure coupler configured to couple with a pressure source,
a lumen,
a pressure orifice configured to align with the cap pressure inlet,
an outlet aperture,
a flow aperture configured to align with the cap flow orifice, and
a repositionable valve core wherein, in a first position:
   the lumen and pressure orifice provide fluid communication between the pressure coupler and the cap pressure inlet, and
   the elongate member comprises a flow path that provides fluid communication between the flow orifice and the outlet aperture, and
   in a second position, fluid communication between the pressure coupler and the cap pressure inlet is disrupted.

### Embodiment 123

The kit of Embodiment 122 wherein the valve core further comprises at least one seal that, when the valve core is in the second position, is proximal to the outlet aperture and when the valve core is in the first position, the seal is distal to the outlet aperture.

### Embodiment 124

The kit of Embodiment 122 or Embodiment 123 wherein the cap further comprises a housing coupler.

### Embodiment 125

The kit of any one of Embodiments 122-124 further comprising a repositionable tip cover wherein, in a first position, the tip cover covers the outlet aperture and, in a second position, uncovers at least a portion of the outlet aperture.

### Embodiment 126

The kit of any one of Embodiments 122-125 further comprising a cap insert configured to sealingly engage with a second fluid reservoir.

### Embodiment 127

The kit of any one of claims 122-126 comprising a plurality of elongate members configured to be interchangeably usable with the cap.

### Embodiment 128

The kit of any one of claims 122-127 comprising a plurality of caps configured to be interchangeably usable with the elongate member.

### Embodiment 129

A flow control device comprising:

a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and

a flow control member adapted to selectively occlude the bleed outlet;

wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area.

### Embodiment 130

The flow control device of Embodiment 129 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 131

The flow control device of Embodiment 130 wherein, in the forward position, the medial portion of the tip end sealingly engages the bleed outlet so that the tip end of the flow control core fully occludes the bleed outlet.

### Embodiment 132

The flow control device of Embodiment 130 or Embodiment 131 wherein, in the retracted position, the tip end of the flow control core does not occlude the bleed outlet.

### Embodiment 133

The flow control device of any preceding Embodiment wherein the inlet is in fluid communication with a source of fluid pressure.

### Embodiment 134

The flow control device of Embodiment 133 wherein the bleed outlet is in fluid communication with a fluid reservoir.

### Embodiment 135

The flow control device of Embodiment 134 wherein the fluid reservoir is in fluid communication with the source of fluid pressure, forming a closed circuit.

### Embodiment 136

The flow control device of any preceding Embodiment wherein the work outlet is in fluid communication with a work apparatus.

### Embodiment 137

The flow control device of Embodiment 136 wherein the work apparatus comprises a liquid dispenser.

### Embodiment 138

The flow control device of any preceding Embodiment wherein the unoccluded bleed flow area is greater than the work outlet flow area.

### Embodiment 139

The flow control device of Embodiment 138 wherein the unoccluded bleed flow area is greater than the work outlet flow area by a ratio of at least 5:1.

### Embodiment 140

The flow control device of any preceding Embodiment wherein moving from the second position to the first position comprises moving the flow control member.

### Embodiment 141

The flow control device of any preceding Embodiment wherein moving from the second position to the first position comprises moving the body.

### Embodiment 142

A method comprising:

providing a flow control device comprising:
a body comprising a body wall that defines a chamber, the body wall comprising an inlet in fluid communication with the chamber, a work outlet comprising a work outlet flow area in fluid communication with the chamber, and a bleed outlet comprising a unoccluded bleed flow area in fluid communication with the chamber; and
a flow control member adapted to selectively occlude the bleed outlet; and moving the flow control member between

(i) a second position wherein the flow control member at least partially occludes the bleed outlet to create a second bleed flow area; and
(ii) a first position wherein the flow control member occludes the bleed outlet to a smaller degree than when in the second position to create a first bleed flow area that is greater than the second bleed flow area.

### Embodiment 143

The method of Embodiment 142 further comprising:

introducing a pressurized fluid to the chamber through the inlet;
wherein as the flow control member is moved from the first position to the second position, fluid pressure through the work outlet increases without a spike from zero pressure.

### Embodiment 144

The method of any of Embodiments 142 or 143 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 145

A method comprising:

providing a flow control device comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and

introducing a pressurized fluid to the chamber through the inlet to establish a first ratio of fluid flow through the bleed outlet relative to the work outlet;

reducing the unoccluded bleed flow area to a second bleed flow area to establish a second ratio of fluid flow through the bleed outlet relative to the work outlet, the second ratio being less than the first ratio.

### Embodiment 146

A system for dispensing a fluid, the system comprising:

a housing comprising a coupler, a pressure outlet, and an actuator; and

a flow control device in controllable communication with the actuator and in fluid communication with the pressure outlet, the flow control device comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and
a flow control member adapted to selectively occlude the bleed outlet;
wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area; and

a dispenser assembly comprising:
a fluid reservoir, and
a cap and valve assembly coupled to the housing via the coupler.

### Embodiment 147

The system of Embodiment 146 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 148

A device for dispensing fluid from a fluid reservoir comprising a coupler, the device comprising:

a housing comprising:
a flow control device in fluid communication with a pressure source and comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and
a flow control member adapted to selectively occlude the bleed outlet;
wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area; and
a pressure outlet in fluid communication with the flow control device;
an actuator engaged with the flow control core of the flow control device; and
a coupler configured to engage a dispenser assembly.

### Embodiment 149

The device of Embodiment 148 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 150

The device of any of Embodiments 148-149 wherein the coupler comprises a clip configured to engage a cap and valve assembly.

### Embodiment 151

An apparatus for dispensing fluid, the apparatus comprising:

a housing that comprises:
a coupler comprising a coupling mechanism configured to sealingly engage at least a portion of a dispenser assembly;
a pressure outlet in fluid communication with a pressure source and configured provide fluid communication with a pressure inlet on the dispenser assembly; and
an actuator configured to actuate a dispenser assembly, thereby delivering pressure to the dispenser assembly from the pressure outlet.

### Embodiment 152

The apparatus of Embodiment 151 wherein the coupling mechanism comprises a clamp configured to engage a coupling platform of the dispenser assembly.

### Embodiment 153

The apparatus of Embodiment 151 or Embodiment 152 wherein the coupler is in fluid communication with a first controller.

### Embodiment 154

The apparatus of any of Embodiments 151-153 wherein the actuator is in fluid communication with a second controller.

### Embodiment 155

The apparatus of Embodiment 154 wherein the first controller and second controller are controlled by a sequencer assembly.

### Embodiment 156

The apparatus of any of Embodiments 151-155 further comprising a flow control device in fluid communication with one or more of: the coupler, the actuator, and the pressure outlet;

the flow control device comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and
a flow control member adapted to selectively occlude the bleed outlet;
wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area.

### Embodiment 157

The apparatus of Embodiment 156 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 158

The apparatus of any of Embodiments 156-157 wherein fluid communication between the flow control device and one or more of the coupler and the actuator comprises fluid communication with an intervening sequencer assembly.

### Embodiment 159

A sequencer assembly comprising:

a body comprising:
a body wall that defines a lumen,
a pressure inlet through the body wall that provides fluid communication between the lumen and a pressure source,
a first sequencer control comprising a first sequencer valve and a first pressure outlet providing fluid communication between the first sequencer control and a first output device, and
a second sequencer control comprising a second sequencer valve and a second pressure outlet providing fluid communication between the second sequencer control and a second output device;

a sequencer core slidably positioned in the lumen, wherein in a first position the sequencer core actuates neither the first sequencer valve nor the second sequencer valve, in a second position the sequencer core actuates both the first sequencer valve and the second sequencer valve, and in an intermediate position between the first position and the second position, the sequencer core actuates the first sequencer valve but not the second sequencer valve.

### Embodiment 160

The sequencer assembly of Embodiment 159 wherein actuating the first sequencer valve releases pressure through the first pressure outlet that actuates the first output device.

### Embodiment 161

The sequencer assembly of Embodiment 160 wherein actuating the second sequencer valve releases pressure through the second pressure outlet that actuates the second output device.

### Embodiment 162

The sequencer assembly of Embodiment 161 wherein moving the sequencer core from the first position to the second position actuates the first sequencer valve and, after a delay, actuates the second sequencer valve.

### Embodiment 163

The sequencer assembly of Embodiment 162 wherein the delay in actuating the second sequencer valve is a function of the distance between the first sequencer valve and the second sequencer valve.

### Embodiment 164

The sequencer assembly of Embodiment 163 wherein the delay in actuating the second sequencer valve is a function of the speed at which the sequencer core is moved from the first position to the second position.

### Embodiment 165

The sequencer assembly of any preceding Embodiment wherein moving the sequencer core from the second position to the first position first de-actuates the second sequencer valve and then de-actuates the first sequencer valve.

### Embodiment 166

The sequencer assembly of Embodiment 165 wherein the second position comprises an overtravel distance such that a time delay exists between initiating moving the sequencer core from the second position to the first position and de-actuating the second sequencer valve.

### Embodiment 167

The sequencer assembly of any preceding Embodiment comprising at least a third sequencer control comprising a third sequencer valve and a third pressure outlet providing fluid communication between the third sequencer control and a third output device.

### Embodiment 168

A method of dispensing a fluid, the method comprising:

providing the system of any of Embodiments 146 or 147; and
actuating the actuator.

### Embodiment 169

A method of dispensing a fluid, the method comprising:

providing the device of any of Embodiments 148-150; and
actuating the actuator.

### Embodiment 170

A method for dispensing a fluid, the method comprising:

providing the apparatus of any one of Embodiments 151-158; and
actuating the actuator.

### Embodiment 171

The method of any one of Embodiments 168-170 wherein the fluid comprises a liquid.

### Embodiment 172

The method of any one of Embodiments 168-171 wherein the fluid comprises a paint component.

### Embodiment 173

A method of delivering a controlled increased air pressure, the method comprising:

providing an apparatus that comprises an actuator in control of a flow control device, the flow control device comprising:
a body comprising a body wall that defines a chamber, the body wall comprising an inlet in fluid communication with the chamber, a work outlet comprising a work outlet flow area in fluid communication with the chamber, and a bleed outlet comprising an unoccluded bleed flow area in fluid communication with the chamber; and
a flow control member adapted to selectively occlude the bleed outlet;
wherein, in a second position, the flow control member at least partially occludes the bleed outlet to create a second bleed flow area and, in a first position, the flow control member occludes the bleed outlet to a smaller degree than when in the second position to create a first bleed flow area that is greater than the second bleed flow area; and

actuating the actuator such that as the flow control core is moved from the retracted position to the forward position, pressure through the work outlet increases without a spike from zero pressure.

### Embodiment 174

The method of Embodiment 173 wherein the flow control member comprises:

a flow control core at least partially within the chamber and controllably repositionable with respect to the chamber, the flow control core comprising:
a body portion in slidable sealing engagement with the body wall;
an actuation control end; and
a tip end, the tip end comprising:
   a medial portion; and
   a distal portion comprising a cross sectional surface area that is less than the unoccluded bleed flow area;

the second position comprising a forward position wherein the tip end of the flow control core at least partially occludes the bleed outlet to create a second bleed flow area; and

the first position comprising a retracted position wherein the tip of end of the flow control core occludes the bleed outlet to a smaller degree than when in the forward position to create a first bleed flow area that is greater than the second bleed flow area.

### Embodiment 175

A cap and valve assembly for use with a system comprising a housing and a fluid reservoir comprising a coupler, the cap and valve assembly comprising:

a cap configured to sealingly engage with the fluid reservoir coupler and comprising a pressure inlet and a flow inlet; and

an elongate member comprising a pressure coupler, a lumen, an outlet aperture, and a repositionable valve core wherein, in a first position:
the lumen provides fluid communication between the pressure coupler and the pressure inlet, and
the elongate member comprises a flow path that provides fluid communication between the flow inlet and the outlet aperture, and
in a second position, fluid communication between the pressure coupler and the pressure inlet is disrupted.

### Embodiment 176

The cap and valve assembly of Embodiment 175 further comprising a housing coupler.

### Embodiment 177

The cap and valve assembly of Embodiment 176 wherein the housing coupler comprises:

a shoulder configured to be received by a mounting slot on the system housing; and

a positioning groove configured to engage a positioning nodule on the system housing.

### Embodiment 178

The cap and valve assembly of any one of Embodiments 175-177 further comprising:

a repositionable tip cover wherein, in a first position, the tip cover covers the outlet aperture and, in a second position, uncovers at least a portion of the outlet aperture.

### Embodiment 179

The cap and valve assembly of Embodiment 178 wherein repositioning the tip cover from the second position to the first position cleans the outlet aperture.

### Embodiment 180

The cap and valve assembly of Embodiment 179 configured so that the tip cap can be positioned to uncover the outlet aperture independent of providing fluid communication between the pressure coupler and the pressure inlet.

### Embodiment 181

The cap and valve assembly of any one of Embodiments 175-180 wherein the valve core further comprises at least one seal that, when the valve core is in the second position, is proximal to the outlet aperture and when the valve core is in the first position, the seal is distal to the outlet aperture.

### Embodiment 182

The cap and valve assembly of Embodiment 181 wherein, when the valve core is in the second position, the seal at least partially obstructs the flow path.

### Embodiment 183

The cap and valve assembly of any one of Embodiments 175-182 further comprising a cap insert configured to sealing engage with a second fluid reservoir coupler.

### Embodiment 184

The cap and valve assembly of any one of Embodiments 175-183 wherein the elongate member is detachable.

### Embodiment 185

The cap and valve assembly of any one of Embodiments 175-184 wherein the elongate member is sufficiently transparent that contents of the lumen are visible.

### Embodiment 186

A kit comprising:

a cap configured to sealingly engage with a fluid reservoir comprising a fluid, the cap comprising a pressure inlet, a flow orifice, and a coupler; and

an elongate member comprising:
a coupler configured to couple with the cap coupler,
a pressure coupler configured to couple with a pressure source,
a lumen,
a pressure orifice configured to align with the cap pressure inlet,
an outlet aperture,
a flow aperture configured to align with the cap flow orifice, and
a repositionable valve core wherein, in a first position:
   the lumen and pressure orifice provide fluid communication between the pressure coupler and the cap pressure inlet, and
   the elongate member comprises a flow path that provides fluid communication between the flow orifice and the outlet aperture, and
   in a second position, fluid communication between the pressure coupler and the cap pressure inlet is disrupted.

### Embodiment 187

The kit of Embodiment 186 wherein the valve core further comprises at least one seal that, when the valve core is in the second position, is proximal to the outlet aperture and when the valve core is in the first position, the seal is distal to the outlet aperture.

### Embodiment 188

The kit of Embodiment 186 or Embodiment 187 wherein the cap further comprises a housing coupler.

### Embodiment 189

The kit of any one of Embodiments 186-188 further comprising a repositionable tip cover wherein, in a first position, the tip cover covers the outlet aperture and, in a second position, uncovers at least a portion of the outlet aperture.

### Embodiment 190

The kit of any one of Embodiments 186-189 further comprising a cap insert configured to sealingly engage with a second fluid reservoir.

### Embodiment 191

The kit of any one of claims 186-190 comprising a plurality of elongate members configured to be interchangeably usable with the cap.

### Embodiment 192

The kit of any one of claims 186-191 comprising a plurality of caps configured to be interchangeably usable with the elongate member.

### Embodiment 193

A coupling mechanism for use with an article that comprises at least one pressure inlet, the coupling mechanism comprising:

a housing configured to receive the device;

a manifold housed by the housing, operably connected to a control pressure source, and configured to deliver a pressure signal;

at least one actuator operably connected to a work pressure source, capable of providing fluid communication between the work pressure source and the pressure inlet of the device, and repositionable from a first position to a second position under the control of a pressure signal delivered by the manifold;

wherein in at least one of the first position and second position, the at least one actuator engages the at least one pressure inlet of the device, thereby providing fluid communication between the work pressure source and the pressure inlet of the device.

### Embodiment 194

A device configured to receive an article comprising a coupling flange, the device comprising:

a repositionable pin in operable communication with a pressure source, wherein a pressure signal from the pressure source repositions the pin from a first position to a second position, wherein:

in the first position, the pin does not engage the coupling flange; and

in the second position, the pin engages the coupling flange, thereby securing the article with the device.

### Embodiment 195

The device of Embodiment 194 wherein the pressure signal may be reversed, thereby repositioning the pin from the second position to the first position.

The foregoing detailed description, examples, and exemplary embodiments have been given for clarity of understanding only. No unnecessary limitations are to be understood therefrom. The invention is not limited to the exact details shown and described, for variations obvious to one skilled in the art will be included within the invention defined by the claims.

Throughout this disclosure, the term “and/or” means one or all of the listed elements or a combination of any two or more of the listed elements; the terms “comprises” and variations thereof do not have a limiting meaning where these terms appear in the description and claims; unless otherwise specified, “a,” “an,” “the,” and “at least one” are used interchangeably and mean one or more than one; and the recitations of numerical ranges by endpoints include all numbers subsumed within that range (e.g., 1 to 5 includes 1, 1.5, 2, 2.75, 3, 3.80, 4, 5, etc.).

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

1-15. (canceled)

16. A cap and valve assembly for use with a system comprising a housing and a fluid reservoir comprising a coupler, the cap and valve assembly comprising:
a cap configured to sealingly engage with the fluid reservoir coupler and comprising a pressure inlet and a flow inlet; and
an elongate member comprising a pressure coupler, a lumen, an outlet aperture, and a repositionable valve core wherein, in a first position:
the lumen provides fluid communication between the pressure coupler and the pressure inlet, and
the elongate member comprises a flow path that provides fluid communication between the flow inlet and the outlet aperture, and
in a second position, fluid communication between the pressure coupler and the pressure inlet is disrupted.

17. The cap and valve assembly of claim 16 further comprising a housing coupler.

18. The cap and valve assembly of claim 17 wherein the housing coupler comprises:
a shoulder configured to be received by a mounting slot on the system housing; and
a positioning groove configured to engage a positioning nodule on the system housing.

19. The cap and valve assembly of claim 16 further comprising:
a repositionable tip cover wherein, in a first position, the tip cover covers the outlet aperture and, in a second position, uncovers at least a portion of the outlet aperture.

20. The cap and valve assembly of claim 19 wherein repositioning the tip cover from the second position to the first position cleans the outlet aperture.

21. The cap and valve assembly of claim 20 configured so that the tip cap can be positioned to uncover the outlet aperture independent of providing fluid communication between the pressure coupler and the pressure inlet.

22. The cap and valve assembly of claim 16 wherein the valve core further comprises at least one seal that, when the valve core is in the second position, is proximal to the outlet aperture and when the valve core is in the first position, the seal is distal to the outlet aperture.

23. The cap and valve assembly of claim 22 wherein, when the valve core is in the second position, the seal at least partially obstructs the flow path.

24. The cap and valve assembly of claim 16 further comprising a cap insert configured to sealing engage with a second fluid reservoir coupler.

25. The cap and valve assembly of claim 16 wherein the elongate member is detachable.

26. The cap and valve assembly of claim 16 wherein the elongate member is sufficiently transparent that contents of the lumen are visible.

27. A kit comprising:
a cap configured to sealingly engage with a fluid reservoir comprising a fluid, the cap comprising a pressure inlet, a flow orifice, and a coupler; and
an elongate member comprising:
a coupler configured to couple with the cap coupler,
a pressure coupler configured to couple with a pressure source,
a lumen,
a pressure orifice configured to align with the cap pressure inlet,
an outlet aperture,
a flow aperture configured to align with the cap flow orifice, and
a repositionable valve core wherein, in a first position:
the lumen and pressure orifice provide fluid communication between the pressure coupler and the cap pressure inlet, and
the elongate member comprises a flow path that provides fluid communication between the flow orifice and the outlet aperture, and
in a second position, fluid communication between the pressure coupler and the cap pressure inlet is disrupted.

28. The kit of claim 27 wherein the valve core further comprises at least one seal that, when the valve core is in the second position, is proximal to the outlet aperture and when the valve core is in the first position, the seal is distal to the outlet aperture.

29. The kit of claim 27 wherein the cap further comprises a housing coupler.

30. The kit of claim 27 further comprising a repositionable tip cover wherein, in a first position, the tip cover covers the outlet aperture and, in a second position, uncovers at least a portion of the outlet aperture.

31. The kit of claim 27 further comprising a cap insert configured to sealingly engage with a second fluid reservoir.

32. The kit of claim 27 comprising a plurality of elongate members configured to be interchangeably usable with the cap.

33. The kit of claim 27 comprising a plurality of caps configured to be interchangeably usable with the elongate member.
